(19) United States
(12) Patent Application Publication
(10) Pub. No.: US 2019/0052798 A1
(43) Pub. Date: Feb. 14, 2019

(54) IMAGING APPARATUS, IMAGING SYSTEM, AND METHOD FOR CONTROLLING IMAGING APPARATUS

(71) Applicant: OLYMPUS CORPORATION, Tokyo (JP)

(72) Inventors: Ko YOKOKAWA, Akishima-shi (JP); Tetsuya SHIROTA, Hachioji-shi (JP); Osamu ONO, Hidaka-shi (JP); Yoshiyuki FUKUYA, Sagamihara-shi (JP); Akira TANI, Sagamihara-shi (JP); Kazuhiko OSA, Hachioji-shi (JP); Osamu NONAKA, Sagamihara-shi (JP)

(73) Assignee: OLYMPUS CORPORATION, Tokyo (JP)

(21) Appl. No.: 16/056,725

(22) Filed: Aug. 7, 2018

(30) Foreign Application Priority Data
Aug. 9, 2017 (JP) 2017-154587

(51) Int. Cl. H04N 5/232

(52) U.S. Cl. CPC H04N 5/23216; H04N 5/232935; H04N 13/204; H04N 5/232945; H04N 5/23212; H04N 5/23296

(57) ABSTRACT

According to an aspect of the invention, an imaging apparatus includes an imaging section, a user's operation detecting circuit, a control circuit, and an image processing circuit. The imaging section is configured to capture images of an object at different imaging positions and output image signals based on the images. The user's operation detecting circuit is configured to detect a user's operation. The control circuit is configured to change an image display range in accordance with the user's operation, and cause the imaging section to capture the images at the different imaging positions in accordance with the changed image display range. The image processing circuit is configured to generate image data using the image signals acquired at the imaging positions. The image data corresponds to an area of the image display range changed by the user's operation.

### CROSS-REFERENCE TO RELATED APPLICATIONS

This application is based upon and claiming the benefit of priority from prior Japanese Patent Application No. 2017-154587, filed Aug. 9, 2017, the entire contents of which are incorporated herein by reference.

### BACKGROUND OF THE INVENTION

### 1. Field of the Invention

The present invention relates to an imaging apparatus, an imaging system, and a method for controlling an imaging apparatus.

### 2. Description of the Related Art

An apparatus that captures an image of an object and acquires an image of the object is required to capture an image or to acquire an observation result, such as a result of imaging, in accordance with an operation of a user. For example, Jpn. Pat. Appln. KOKAI Publication No. 2017-42592 discloses a technique relating to an apparatus that, in an area with reference to a position where a tap, a long time depression, or a flick on a touch panel by a user is detected, changes a parameter which influences an image display in accordance with at least one of the strength of the tap, the number of taps, the strength of the long time depression, the time length of the long time depression, the strength of the flick, the direction of the flick, and the speed of the flick.

### BRIEF SUMMARY OF THE INVENTION

According to an aspect of the invention, an imaging apparatus includes an imaging section, a user's operation detecting circuit, a control circuit, and an image processing circuit. The imaging section is configured to capture images of an object at different imaging positions and output image signals based on the images. The user's operation detecting circuit is configured to detect a user's operation. The control circuit is configured to change an image display range in accordance with the user's operation, and cause the imaging section to capture the images at the different imaging positions in accordance with the changed image display range. The image processing circuit is configured to generate image data using the image signals acquired at the imaging positions. The image data corresponds to an area of the image display range changed by the user's operation.

According to an aspect of the invention, an imaging system includes the imaging apparatus and a controller including an operation section configured to acquire a result of the user's operation.

According to an aspect of the invention, a method for controlling an imaging apparatus including an imaging section configured to capture images of an object at different imaging positions and output image signals based on the images is provided. The method includes detecting a user's operation, changing an image display range in accordance with the user's operation, causing the imaging section to capture the images at the different imaging positions in accordance with the changed image display range, and generating image data using the image signals acquired at the imaging positions, the image data corresponding to an area of the image display range set by the user's operation.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an outline of an appearance of an observation system according to a first embodiment.

FIG. 2 is a schematic diagram showing an outline of a configuration example of the observation system according to the first embodiment.

FIG. 3 is a side view showing an outline of a configuration example of a periphery of a sample according to the first embodiment.

FIG. 4 is a flowchart illustrating an example of observation apparatus control processing according to the first embodiment.

FIG. 5 is a flowchart illustrating an example of processing performed by a controller according to the first embodiment.

FIG. 6A is a schematic view for explaining an example of a zoom operation to instruct zooming in and an image display range according to the first embodiment.

FIG. 6B is a schematic view for explaining an example of a zoom operation to instruct zooming in and an image display range according to the first embodiment.

FIG. 7A is a schematic view for explaining an example of a zoom operation to instruct zooming out and an image display range according to the first embodiment.

FIG. 7B is a schematic view for explaining an example of a zoom operation to instruct zooming out and an image display range according to the first embodiment.

FIG. 8 is a flowchart illustrating an example of count scan processing according to the first embodiment.

FIG. 9 is a schematic diagram showing an example of information stored as count scan processing information according to the first embodiment.

FIG. 10 is a schematic diagram showing an example of a movement pattern of an image acquisition unit in the count scan processing according to the first embodiment.

FIG. 11 is a flowchart illustrating an example of observation processing according to the first embodiment.

FIG. 12 is a flowchart illustrating an example of enlargement processing according to the first embodiment.

FIG. 13 is a schematic diagram showing an example of a movement pattern of the image acquisition unit in the enlargement processing according to the first embodiment.

FIG. 14 is a flowchart illustrating an example of reduction processing according to the first embodiment.

FIG. 15 is a schematic diagram showing an example of a movement pattern of the image acquisition unit in the reduction processing according to the first embodiment.

FIG. 16A is a schematic view for explaining acquisition of supplemental information in a case of a user's zoom operation to instruct zooming out of a predetermined amount or more in observation processing according to a second embodiment.

FIG. 16B is a schematic view for explaining acquisition of supplemental information in a case of a user's zoom operation to instruct zooming out of a predetermined amount or more in observation processing according to the second embodiment.

FIG. 16C is a schematic view for explaining acquisition of supplemental information in a case of a user's zoom operation to instruct zooming out of a predetermined amount or more in observation processing according to the second embodiment.

FIG. 17 is a flowchart illustrating an example of processing performed by a controller according to the second embodiment.

### DETAILED DESCRIPTION OF THE INVENTION

### First Embodiment

There is a demand for a technique relating to an imaging apparatus that, even in the case of a shortage of information on an acquired image, can easily acquire supplemental information which compensates for the shortage of information. In this embodiment described below, an imaging apparatus acquires supplemental information by imaging to compensate for a shortage of information caused by a user's operation, and can generate image data corresponding to the user's operation. In the following, an observation apparatus as an example of the imaging apparatus will be explained. Furthermore, in the example described below, the user's operation that chiefly causes a shortage of information is assumed to be a zoom operation.

<Configuration of Measurement System>

(Outline of Observation System)

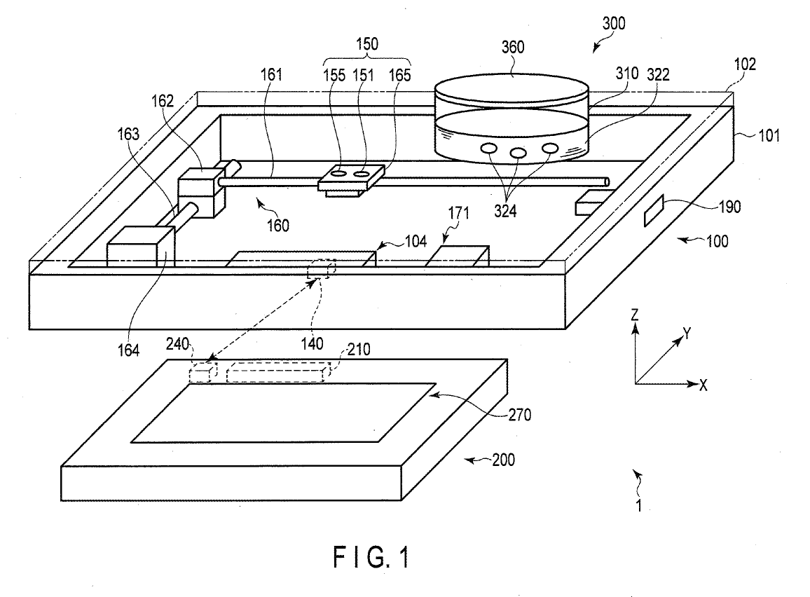

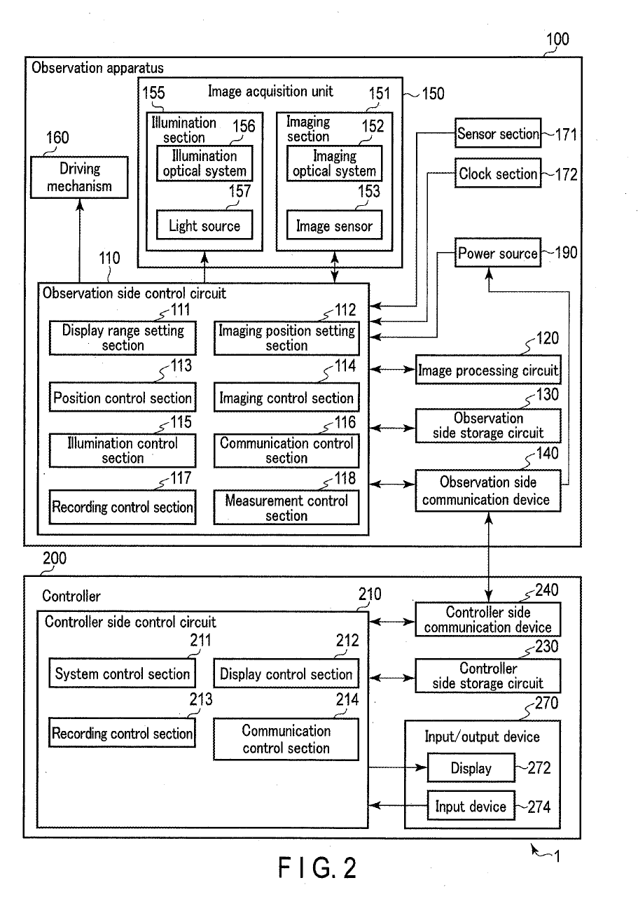

The first embodiment of the present invention will be explained with reference to the drawings. An observation system of this embodiment is an imaging system which takes images of a cell, a cell group, and a tissue which are being cultured, and which makes a record of the numbers of cells or cell groups and the form thereof. FIG. 1 is a schematic view illustrating an outline of the appearance of an observation system 1. FIG. 2 is a block diagram illustrating a configuration example of the observation system 1. As shown in FIG. 1 and FIG. 2, the observation system 1 includes an observation apparatus 100, as the imaging apparatus, and a controller 200.

As shown in FIG. 1, the observation apparatus 100 includes a casing 101, a transparent plate 102, and an image acquisition unit 150. The observation apparatus 100 is approximately plate-shaped. The transparent plate 102 is placed as a top plate of the observation apparatus 100. A sample 300 to be observed is arranged on the transparent plate 102. The image acquisition unit 150 is provided inside a casing 101. The image acquisition unit 150 takes an image of the sample 300, via the transparent plate 102 interposed, and the image of the sample 300 is acquired thereby. The observation apparatus 100 in which the sample 300 is arranged to be placed, for example, inside an incubator.

On the other hand, the controller 200 is provided, for example, on the outside of the incubator. The observation apparatus 100 and the controller 200 communicate with each other. The controller 200 controls operations of the observation apparatus 100.

For the sake of explanation, an x-axis and a y-axis perpendicular to each other are defined in a plane parallel to the surface of the observation apparatus 100 on which the sample 300 is arranged, and a z-axis is defined as an axis perpendicular to both the x-axis and the y-axis.

### (Sample)

An example of the sample 300 to be observed by the observation system 1 will be described below. The sample 300 includes, for example, a vessel 310, a culture medium 322, cells 324, and a reflecting plate 360. The culture medium 322 is in the vessel 310, and cells 324 are cultured in the culture medium 322. The vessel 310 may be, for example, a Petri dish, a culture flask, a multi-well plate, or the like. The vessel 310 is a culture vessel for culturing a biological sample, for example. The vessel 310 is not limited to any specific shape or size. The culture medium 322 may be either a liquid medium or a solid medium. The cells 324 to be measured may be either adhesive cells or floating cells. Alternatively, the cells 324 may be spheroids or tissues. In addition, the cells 324 may be derived from any organism or may be bacteria or the like. As described above, the sample 300 includes a living sample which is either the living substance itself, or is derived from the living substance. The reflecting plate 360 reflects part of illumination light entered to the sample 300 via the transparent plate 102. The reflected illumination light illuminates the cells 324. The reflecting plate 360 is placed as a top plate of the vessel 310.

### (Observation Apparatus)

The transparent plate 102 is provided on top of the casing 101 of the observation apparatus 100. The transparent plate 102 is made of, for example, glass. The inside of the observation apparatus 100 is sealed by a member including, for example, the casing 101 and the transparent plate 102. The sample 300 is statically placed on this transparent plate 102. Although FIG. 1 shows that the top plate of the casing 101 is entirely transparent, the observation apparatus 100 may be designed so that part of the top plate of the casing 101 is a transparent plate, and the remaining part of the top plate is opaque.

As shown in FIG. 2, the image acquisition unit 150 includes an imaging section 151 and an illumination section 155. The imaging section 151 includes an imaging optical system 152 and an image sensor 153. The image sensor 153 is, for example, a charge coupled device (CCD) or a complementary metal-oxide semiconductor (CMOS) sensor. The imaging section 151 generates an image signal based on an image which is formed on an imaging plane of the image sensor 153 via an imaging optical system 152. The imaging section 151 outputs the generated image signal. The illumination section 155 is provided near the imaging section 151, as shown in FIG. 1. The illumination section 155 includes an illumination optical system 156 and a light source 157, as shown in FIG. 2. The light source 157 is, for example, a light-emitting diode (LED). Illumination light of this embodiment is, for example, red light, to reduce damaging the cells 324. The illumination light emitted from the light source 157 illuminates the sample 300 through the illumination optical system 156.

As shown in FIG. 1, the image acquisition unit 150 further includes a support section 165. The support section 165 is provided with the imaging section 151 and the illumination section 155.

A driving mechanism 160 includes an X feed screw 161 and an X actuator 162. The X feed screw 161 and the X actuator 162 moves the support section 165 in an X-axis direction. The driving mechanism 160 further includes a Y feed screw 163 and a Y actuator 164. The Y feed screw 163 and the Y actuator 164 move the support section 165 in a Y-axis direction. The driving mechanism 160 may be provided with a Z feed screw and a Z actuator for moving the support section 165 in a Z-axis direction. For the purpose of explanation in the following, a direction in which the support section 165 moves away from the X actuator 162 is referred to as a positive direction of the X direction (an X+ direction). A direction in which the support section 165 moves away from the Y actuator 164 is referred to as a positive direction of the Y direction (a Y+ direction). A direction from the support section 165 toward the sample 300 is referred to as a positive direction of the Z direction (a Z+ direction).

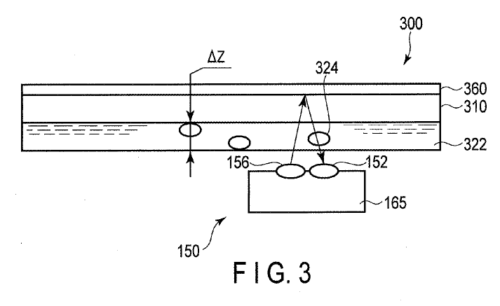

FIG. 3 is a schematic view showing an outline of a configuration example of the image acquisition unit 150 and the sample 300. As shown in FIG. 3, the illumination light emitted through the illumination optical system 156 of the illumination section 155 is incident on and reflected by the reflecting plate 360 on top of the vessel 310. The reflected light illuminates the cells 324. The light that illuminates the cells 324 enters the imaging optical system 152 of the imaging section 151. The imaging section 151 images a light beam that is incident on the imaging plane of the image sensor 153 via the imaging optical system 152.

Thus, the observation apparatus 100 of this embodiment moves the image acquisition unit 150 by the driving mechanism 160, and changes the relative position between the sample 300 and the imaging section 151. The imaging section 151 repeatedly captures images of the sample 300, while the imaging position is changed in the X direction and the Y direction, and outputs image signals acquired in various imaging positions. The imaging position in the Z-axis direction may be changed by the driving mechanism 160, or may be changed by changing a focus position of the imaging optical system 152.

The observation apparatus 100 further includes an observation side storage circuit 130. The observation side storage circuit 130 stores, for example, programs and parameters to be used in elements of the observation apparatus 100, and data obtained by the observation apparatus 100. The observation side storage circuit 130 temporarily stores various kinds of data, such as an image signal, image data, image data for storage or display, or in-processing data in operation. The image data includes pixel data. Furthermore, the observation side storage circuit 130 stores information relating to a movement pattern of the image acquisition unit 150 in observation and measurement. The movement pattern includes a C movement pattern in count scan processing to be described later, and a T movement pattern and a W movement pattern in supplemental information acquisition processing to be described later. The observation side storage circuit 130 stores a range of a focus position in an optical axis direction of the imaging optical system 152 as a focus position range AZ. The value of the focus position range AZ is set in advance in accordance with a size of the sample 300, or set by the user's input.

The observation apparatus 100 further includes an image processing circuit 120. The image processing circuit 120 performs image processing for an image signal, image data, etc. The image processing circuit 120 generates captured image data using an image signal output from the imaging section 151. The captured image data may be generated by the imaging section 151. The image processing circuit 120 performs super-resolution processing using a plurality of pieces of captured image data, and generates super-resolution image data. The image processing circuit 120 pastes a plurality of pieces of captured image data arranged side by side to synthesize an image like a panoramic image, thereby generating wide-range image data. The image data obtained by various image processing in the image processing circuit 120 is stored in the observation side storage circuit 130, or is transmitted to the controller 200.

The image processing circuit 120 may perform various kinds of analysis, based on the obtained image data. For example, the image processing circuit 120 extracts an image of a cell 324 or cell group included in the sample 300, or counts the number of cells 324 or cell groups, based on the obtained image data or image signal. The results of the analysis thus obtained are stored in the observation side storage circuit 130 or transmitted to the controller 200.

To perform communication between the observation apparatus 100 and the controller 200 described above, the observation apparatus 100 further includes an observation side communication device 140. Wireless communications such as Wi-Fi or Bluetooth is utilized for the communications. The observation apparatus 100 and the controller 200 may be connected by a cable, and cable communications may be performed between them. Alternatively, the observation apparatus 100 and the controller 200 may be connected to a telecommunications circuit, such as the Internet, and communications may be performed therebetween via the telecommunications circuit, such as the Internet. The observation apparatus 100 acquires from the controller 200 a control signal corresponding to the user's operation, via the observation side communication device 140. In other words, the observation side communication device 140 can be represented as an example of a user's operation detection circuit which detects the user's operation.

The observation apparatus 100 further includes an observation side control circuit 110, a sensor section 171, a clock section 172, and a power source 190.

The observation side control circuit 110 controls operations of each of the elements of the observation apparatus 100. Furthermore, the observation side control circuit 110 acquires various information relating to operations of the observation apparatus 100, performs various determinations relating to the operations of the observation apparatus 100, and provides the user with an alert or warning based on a result of the determination.

As shown in FIG. 2, the observation side control circuit 110 functions as a display range setting section 111, an imaging position setting section 112, a position control section 113, an imaging control section 114, an illumination control section 115, a communication control section 116, a recording control section 117, and a measurement control section 118.

The display range setting section 111 sets an image display range. The image display range is a range of information to be indicated as image data. Information necessary to generate image data corresponding to the image display range is referred to as display composing information. The image display range corresponds to a display range of, for example, image data, when the image data is displayed. The image data corresponding to the image display range may be represented as image data corresponding to an area of the image display range. The image display range is set on the basis of a result of the user's zoom operation acquired from the controller 200. In other words, the observation side control circuit 110, functioning as the display range setting section 111, can be represented as an example of the user's operation detection circuit that detects the user's operation, based on the control signal corresponding to the user's operation acquired from the controller 200. The display range setting section 111 further determines whether there is a shortage of information regarding the display composing information relating to the set image display range. In other words, the display range setting section 111 determines whether or not it is necessary to acquire supplemental information to compensate for the shortage of information caused by a zoom operation. The display range setting section 111 further sets an acquired range and an information shortage range in the set image display range based on a result of the determination. The acquired range is an image display range corresponding to the information that is already acquired, out of the display composing information. In the following, the information that is already acquired, out of the display composing information, is referred to as acquired information. For example, the acquired information includes image data generated just before the image display range is set. On the other hand, the information shortage range is an image display range corresponding to the shortage information out of the display composing information. In the following, the information that is short, out of the display composing information, is referred to as supplemental information.

For example, if the display range setting section 111 acquires a control signal relating to a zoom operation, it sets an image display range indicated as image data after zooming. The zoom operation is an enlargement operation to instruct zooming in or a reduction operation to instruct zooming out. Thereafter, the display range setting section 111 sets an acquired range by comparing the acquired image signal or image data with the set image display range.

If the display range setting section acquires a control signal relating to an enlargement operation, in this embodiment, it not only enlarges the image in the image display range in accordance with the zoom operation, but also enlarges the image in accordance with the image display range after super-resolution processing is performed. Therefore, when the super-resolution image data corresponding to the set image display range is generated by super-resolution processing, the display range setting section 111 determines supplemental information that is required in addition to information corresponding to the acquired range, and sets an information shortage range. In this case, the information shortage range is a range shifted from the acquired image signal or image data by an amount corresponding to less than one pixel and greater than 0. The information corresponding to the acquired range is the acquired image signal or image data. The supplemental information is information corresponding to the information shortage range.

Furthermore, if a control signal corresponding to the reduction operation is acquired, the display range setting section 111 determines supplemental information that is required when the wide-ranges image data corresponding to the set image display range is generated, in addition to the information corresponding to the acquired range, and sets an information shortage range. In this case, the information shortage range is, for example, a range shifted from the acquired image signal or image data by an amount corresponding to one imaging range.

As described above, the display range setting section 111 according to this embodiment sets an image display range in accordance with the zoom operation by the user, determines supplemental information necessary to compensate for a shortage of information caused by the zoom operation, and sets the information shortage range where information acquisition to compensate for the shortage of information is performed. The information acquisition to compensate for the shortage of information is, for example, image capturing.

The imaging position setting section 112 sets an imaging position based on the image display range or the information shortage range set by the display range setting section 111. The imaging position is a position where the imaging section 151 captures an image. For example, assuming that the range in which the imaging section 151 can capture an image is an imaging range, the imaging position setting section 112 compares the image display range with the imaging range, and sets the imaging position. In this embodiment, it is assumed that the size of the imaging range on the X-Y plane does not vary each time image capturing is performed. In other words, in the present embodiment described below as an example, the focal length of the imaging section 151 is constant. An image signal acquired at the set imaging position is information corresponding to the image display range. Even if there is an acquired range, information corresponding to the acquired range may be acquired again by image capturing.

The position control section 113 controls the driving mechanism 160 to control the position of an image acquisition unit 150. In other words, the position control section 113 controls the operation of the driving mechanism 160 so that the imaging section 151 moves to the set imaging position.

The imaging control section 114 controls the operation of the imaging section 151 included in the image acquisition unit 150. The imaging control section 114 causes the imaging section 151 to acquire an image of the sample 300 at the set imaging position. The range of the sample 300 imaged at a specific imaging position is an imaging range of the imaging section 151 at the specific imaging position. The imaging control section 114 causes the imaging section 151 to acquire an image of the sample 300 at different imaging ranges. The imaging control section 114 functions as a focus exposure switching section. The imaging control section 114 performs focus control, for example, by moving a focusing lens included in the imaging optical system 152. The focusing lens may be, for example, a liquid lens which has a variable-focal length. Alternatively, a plurality of lens with different focal lengths may be prepared for focusing. If a multi-eye lens is prepared, a refocusing technique can be utilized. Furthermore, the focus exposure switching section may, for example, adjust exposure by controlling an operation of the aperture, or adjust optical zooming by controlling an operation of the lens in the optical axis direction.

The illumination control section 115 controls the operation of the illumination section 155 included in the image acquisition unit 150. The communication control section 116 controls the communications between the observation apparatus 100 and the controller 200 performed using the observation side communication device 140. The recording control section 117 controls the recording of data obtained by the observation apparatus 100. The measurement control section 118 controls the overall measurement, including measurement timing and the number of times the measurement is performed.

The sensor section 171 includes, for example, a temperature sensor, a humidity sensor, and a pressure sensor. The sensor section 171 measures, for example, a temperature, humidity, pressure, or the like inside the observation apparatus 100, and outputs the measurement values to the observation side control circuit 110. The sensor section 171 may be arranged so as to additionally measure a temperature, humidity, pressure, or the like outside the observation apparatus 100.

The clock section 172 generates and outputs time information to the observation side control circuit 110. The time information is used in, for example, recording acquired data and determinations relating to operations of the observation apparatus 100.

The power source 190 supplies power to each of the elements included in the observation apparatus 100. The power source 190 may include an operation section that acquires a result of an operation by the user. The operation section includes, for example, a button, a switch, a dial, a lever, and a touch panel. The user operates the operation section, for example, to turn on/off the power of the observation apparatus 100, and to set the observation apparatus 100 in a standby state.

The observation side control circuit 110, the image processing circuit 120, the observation side storage circuit 130, and the observation side communication device 140 may be arranged inside the casing 101 as a circuit group 104, as shown in FIG. 1. Alternatively, the observation side control circuit 110, the image processing circuit 120, the observation side storage circuit 130, and the observation side communication device 140 may be arranged inside the image acquisition unit 150.

As described above, the image acquisition unit 150 that generates image data by imaging via the transparent plate 102 and the driving mechanism 160 that moves the image acquisition unit 150, are provided inside the casing 101. Accordingly, the structure of the apparatus can be reliable, easy to handle and clean, and can prevent contamination or the like.

### (Controller)

The controller 200 is, for example, a personal computer (PC) or a tablet type information terminal. In FIG. 1, a tablet type information terminal is depicted.

The controller 200 is provided with an input/output device 270 including a display 272 such as a liquid crystal display, and an input device 274 such as a touch panel. The input device 274 is not limited to the touch panel, but may include a switch, a dial, a keyboard, a mouse, etc. The input device 274 can be represented as an example of the user's operation detection circuit which detects the user's operation.

The controller 200 is also provided with a controller side communication device 240. The controller side communication device 240 is a device which communicates with the observation side communication device 140. The observation apparatus 100 and the controller 200 communicate with each other through the observation side communication device 140 and the controller side communication device 240.

The controller 200 is further provided with a controller side control circuit 210 and a controller side storage circuit 230. The controller side control circuit 210 controls operations of each of the elements of the controller 200. The controller side storage circuit 230 stores, for example, programs and various parameters for use in the controller side control circuit 210. The controller side storage circuit 230 also stores, for example, data received from the observation apparatus 100.

The controller side control circuit 210 functions as a system control section 211, a display control section 212, a recording control section 213, and a communication control section 214. The system control section 211 performs various operations for controlling the measurement of the sample 300. The display control section 212 controls operations of the display 272. The display control section 212 causes the display 272 to display the necessary information. The recording control section 213 controls the recording of information in the controller side storage circuit 230. The communication control section 214 controls the communications with the observation apparatus 100 that are performed using the controller side communication device 240. The controller side control circuit 210 can be represented as an example of the user's operation detection circuit which detects user's operation based on the control signal in accordance with the user's operation output from the input device 274.

Each of the observation side control circuit 110, the image processing circuit 120, and the controller side control circuit 210 incorporates a central processing unit (CPU), an application specific integrated circuit (ASIC), an integrated circuit such as a field programmable gate array (FPGA), or the like. The observation side control circuit 110, the image processing circuit 120, and the controller side control circuit 210 may be each constituted by a single integrated circuit, etc., or by a combination of multiple integrated circuits, etc. The observation side control circuit 110 and the image processing circuit 120 may be made by a single integrated circuit. The operations of these integrated circuits are executed, for example, in accordance with programs stored in the observation side storage circuit 130 or the controller side storage circuit 230, or in accordance with the programs stored in the storage regions of the integrated circuits.

Each of the observation side storage circuit 130 and the controller side storage circuit 230 is a non-volatile memory, such as a flash memory, and they may further include a volatile memory, such as a static random access memory (SRAM) and a dynamic random access memory (DRAM). The observation side storage circuit 130 and the controller side storage circuit 230 may be each constituted by a single memory, etc., or by a combination of a plurality of memories, etc. A database outside the observation system 1 may be of course used as a part of the memory.

<Operations of Observation System>

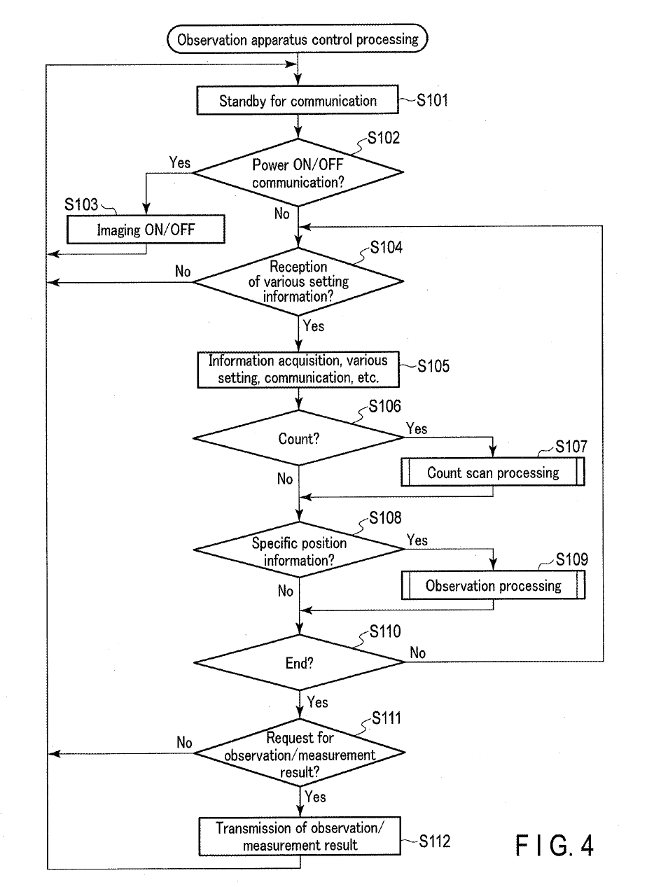

FIG. 4 is a flowchart illustrating an example of observation apparatus control processing according to this embodiment. In the following, operations of the observation system 1 will be explained with reference to FIG. 4. The processing explained below is started in the state where the observation apparatus 100 with the sample 300 placed on top thereof is disposed in an incubator.

In step S101, the observation side control circuit 110 stands by until receiving a signal output from the controller 200 in accordance with the user's operation.

In step S102, the observation side control circuit 110 determines, for example, whether or not a power ON signal or a power OFF signal was received from the controller 200. The power ON signal is a signal that powers on the observation apparatus 100. The power OFF signal is a signal that powers off the observation apparatus 100. The processing proceeds to step S103 if it is determined that the power ON or OFF signal was received. If not, the processing proceeds to step S104. If the observation side control circuit 110 determines that the power ON signal was received in step S102, it causes the power source 190 in step S103 to start supplying power to the elements of the observation apparatus 100. If the observation side control circuit 110 determines that the power OFF signal was received in step S102, it causes the power source 190 to end supplying power to the elements of the observation apparatus 100. In either case, the power is continuously supplied to the observation side communication device 140 to stand by for communication. The processing then returns to step S101.

The observation apparatus 100 may include a standby-power saving-type communication device, such as a Bluetooth Low Energy (BLE) device, for transmission and reception of a control signal etc., and a high-speed communication device, such as a Wi-Fi device, for transmission and reception of data of observation results including an image. In this case, if the power of the observation apparatus 100 is off, it stands by for communications by the BLE device or the like, and if the power is turned on in step S103, communications with the controller 200 may be established with the Wi-Fi device or the like. In the example described above, the observation apparatus 100 is turned on or off based on the power ON/OFF signal output from the controller 200; however, the embodiment is not limited to the example. The power source of the observation apparatus 100 may be turned on and off at preset time intervals, for example, one minute. When cell culturing is observed, if a change of the object under observation with the passage of time is gradual, for example, observation, such as image capturing, may be carried out at time intervals as required. Therefore, the power control as described above contributes to energy saving.

In step S104, the observation side control circuit 110 determines, for example, whether or not a control signal relating to various settings was received from the controller 200. The processing proceeds to step S105 if it is determined that the control signal relating to various settings was received. If not, the processing returns to step S101.

In step S105, the observation side control circuit 110 carries out setting of elements of the observation apparatus 100 in accordance with the control signal relating to various settings received by the observation side communication device 140 instep S104. The information set in this step includes, for example, information on the destination of an observation result or a measurement result for an image acquired by the observation apparatus 100, imaging conditions, measurement conditions, and various parameters. The destination of the observation result or the measurement result acquired by the observation apparatus 100 is, for example, the observation side storage circuit 130 of the observation apparatus 100, the controller side storage circuit 230 of the controller 200, or a data server on a network. For example, if the observation result or the measurement result is transmitted to a cloud or the like constituted on the network, information can be easily shared between different users. Moreover, the acquired image can be analyzed or subjected to image processing outside the observation system 1.

In step S106, the observation side control circuit 110 determines whether or not a control signal instructing execution of count scan processing was received from, for example, the controller 200. The processing proceeds to step S107 if it is determined that the control signal instructing the execution of count scan processing was received. If not, the processing proceeds to step S108. Start time of the count scan processing may be determined in advance, so that the count scan processing can be started at the determined start time. In step S107, the observation side control circuit 110 carries out count scan processing and counts the number of cells 324. The count scan processing will be detailed later. Then, the processing proceeds to step S108.

In step S108, the observation side control circuit 110 determines, for example, whether or not specific position information was received from the controller 200. The specific position information is position information indicative of an observation position or an observation range instructed by the user. The processing proceeds to step S109 if it is determined that the specific position information was received. If not, the processing proceeds to step S110. In step S109, the observation side control circuit 110 executes observation processing based on the specific position information. The observation processing will be detailed later. Then, the processing proceeds to step S110.

In step S110, the observation side control circuit 110 determines whether or not the processing relating to the observation or measurement should be ended, for example, on the basis of the control signal output from the controller 200 in accordance with the user's operation.

The processing proceeds to step S111, if it is determined that the processing should be ended. If not, the processing returns to step S104.

In step S111, the observation side control circuit 110 determines, for example, whether or not a control signal requesting an observation result or a measurement result was received from the controller 200. The observation result or the measurement result includes various data obtained by the observation apparatus 100, such as a measurement value obtained by measurement, an acquired image, an imaging position, or an analysis result. The imaging position includes an X coordinate, a Y coordinate, and a Z coordinate of the imaging position. The processing proceeds to step S112 if it is determined that the control signal requesting the observation result or the measurement result was received. If not, the processing returns to step S101.

In step S112, the observation side control circuit 110 transmits a result acquired by various observation or measurement of an acquired image, an analysis result acquired by analyzing the result, etc. to the destination set in, for example, step S105. The information transmitted in this step includes image data corresponding to the image display range generated by adding supplemental information to the acquired information by the image processing circuit 120. The image data may be generated in the destination, such as the controller 200. The processing then returns to step S101.

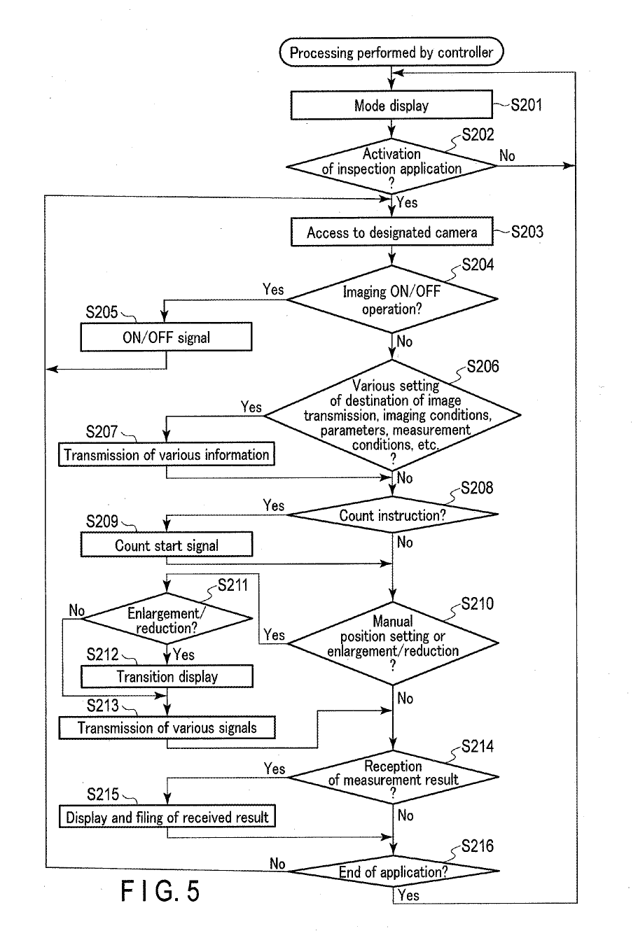

FIG. 5 is a flowchart illustrating an example of processing performed by the controller 200. In the following, operations of the observation system 1 will be explained with reference to FIG. 5. The processing shown in the flowchart of FIG. 5 is started, for example, in the state where the observation apparatus 100 stands by for communications. In the following, explanations are given referring to corresponding steps in the observation apparatus control processing described above with reference to FIG. 4.

In step S201, the controller side control circuit 210 generates display information to inform the user of, for example, various functions of the controller 200 with a text, an icon, etc., and displays it on the display 272.

In step S202, the controller side control circuit 210 determines whether or not activation of an inspection application is instructed based on, for example, a control signal output from the input device 274 in accordance with a result of the user's operation. The inspection application is application software including a program to control the observation apparatus 100 in communication with the observation apparatus 100. The processing proceeds to step S203, if it is determined that the activation of the inspection application is instructed. If not, the processing returns to step S201. The controller 200 is, for example, a tablet PC or a smartphone. As well as the inspection application, a telephone application or a mail application may be selected in this step. In the following, the case in which the inspection application is selected will be explained as an example.

In step S203, the controller side control circuit 210 accesses a designated camera. The designated camera is, for example, an imaging device to capture an image of an object to be controlled by the inspection application selected in step S202. The explanations will be continued below on the assumption that the designated camera is the observation apparatus 100.

In step S204, the controller side control circuit 210 determines whether or not the user performs an imaging ON operation or an imaging OFF operation based on, for example, a control signal output from the input device 274 in accordance with a result of the user's operation. The imaging ON operation includes an operation of turning on the observation apparatus 100 for imaging. The imaging OFF operation includes an operation of turning off the observation apparatus 100. The processing proceeds to step S205 if it is determined that the imaging ON or OFF operation is performed. If not, the processing proceeds to step S206.

In step S205, the controller side control circuit 210 causes the controller side communication device 240 to transmit to the observation apparatus 100 the power ON signal to power on the observation apparatus 100, or the power OFF signal to power off the observation apparatus 100, based on the result of the imaging ON or OFF operation by the user detected in step S204. The processing then returns to step S203. The processing of this step corresponds to step S102 and step S103.

In step S206, the controller side control circuit 210 determines whether or not the user has executed various settings, which includes information on the destination of the observation result, or the measurement result of the image acquired by the observation apparatus 100, imaging conditions, measurement conditions, and various parameters. The determination is performed based on, for example, a control signal output from the input device 274 in accordance with a result of the user's operation. The processing proceeds to step S207 if it is determined that various settings were executed. If not, the processing proceeds to step S208.

In step S207, the controller side control circuit 210 causes the controller side communication device 240 to transmit the control signal relating to the various settings detected in step S206 to the observation apparatus 100. Thereafter, the processing proceeds to step S208. The processing of this step corresponds to step S104 and step S105.

In step S208, the controller side control circuit 210 determines whether or not the user instructed the execution of count scan processing. The determination is performed based on, for example, a control signal output from the input device 274 in accordance with a result of the user's operation. The processing proceeds to step S209 if it is determined that the execution of count scan processing was instructed. If not, the processing proceeds to step S210.

In step S209, the controller side control circuit 210 causes the controller side communication device 240 to transmit a control signal to instruct the execution of count scan processing to the observation apparatus 100. Thereafter, the processing proceeds to step 210. The processing of this step corresponds to step S106 and step S107.

In step S210, the controller side control circuit 210 determines whether or not the user performed manual position setting. The manual position setting is setting of a specific position where observation or measurement is to be executed. The determination is performed based on, for example, a control signal output from the input device 274 in accordance with a result of the user's operation. The determination can be represented as a determination of whether or not the user instructed the execution of the observation at the specific position. The controller side control circuit 210 also determines whether or not the user performed a zoom operation that instructs zooming in or zooming out. The processing proceeds to step S211 if it is determined that the manual position setting or the zoom operation was performed. If not, the processing proceeds to step S214. The processing of this step corresponds to step S108 and step S109.

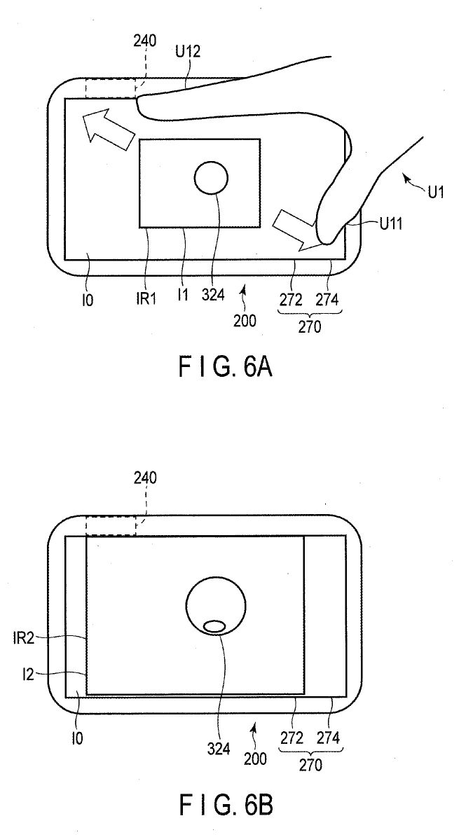

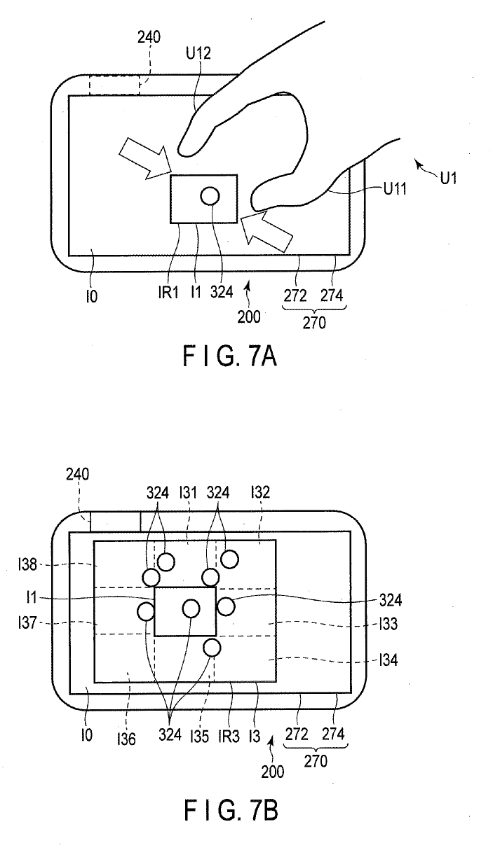

FIG. 6A and FIG. 6B are schematic views for explaining an example of an enlargement operation as a zoom operation to instruct zooming in and an image display range. FIG. 7A and FIG. 7B are schematic views for explaining an example of a reduction operation as a zoom operation to instruct zooming out, and an image display range. In the following description, the input device 274 of the controller 200 is assumed to be a touch panel disposed on the display 272. The controller 200 may be, for example, placed on a desk or held by the left hand of a user U1. It is assumed that the user U1 operates the controller 200 by the right hand. As shown in FIG. 6A and FIG. 7A, for example, it is assumed that captured image data I1 obtained by capturing images of the cells 324 is displayed on the display 272 of the controller 200. In this case, the captured image data I1 is image data corresponding to an image display range IR1.

For example, the user U1 may desire to acquire image data I2 corresponding to an image display range IR2 as shown in FIG. 6B to observe the cells 324 in more detail. In this case, the user U1 performs an enlargement operation as the zoom operation to instruct zooming in by moving the thumb U11 and the index finger U12 of the right hand to increase the distance therebetween on the touch panel, as shown in FIG. 6A. Such an operation by the user may be expressed as a pinch operation. The pinch operation in the zooming in is a pinch-out operation.

On the other hand, the user U1 may desire to acquire image data I3 corresponding to an image display range IR3 as shown in FIG. 7B to observe a periphery of the cells 324. In this case, the user U1 performs a reduction operation as the zoom operation to instruct zooming out by moving the thumb U11 and the index finger U12 of the right hand to narrow the distance therebetween on the touch panel, as shown in FIG. 7A. The pinch operation in the zooming out is a pinch-in operation.

In this embodiment, such an operation is considered to be an intuitive operation which the user performs even unconsciously. Such an operation may be performed when the user feels something unsatisfactory about the currently displayed image. In this case, the operation may, for example, be considered as an operation that reflects the user's need or intention to observe the image in more detail by enlarging the image. The operation may also be considered as an operation that reflects the user's need or intention to observe the image more comprehensively, for example, by reducing the image. The technique of this embodiment can find out such a need of the user and improve the user's satisfaction level by reflecting the need on the display style. The user's operation as described above may not necessarily be performed intuitively. If the user finds that the operation can produce a particular advantage, the user may consciously execute it, and the application of this for better observation can be sufficiently presumed. Using the technique of this embodiment, various displays can be seen by intuitive operations as described above. Therefore, the user can switch between displays with a single touch without performing many operations, which are otherwise required.

Referring back to FIG. 5 again, explanation of the processing performed by the controller 200 will be continued. In step S211, the controller side control circuit 210 determines whether or not the operation determined to be performed in step S210 is a zoom operation instructing enlargement or reduction. The processing proceeds to step S212 if the operation is determined to be a zoom operation. If not, that is, if the operation determined to be performed in step S210 is manual position setting, the processing proceeds to step S213.

In step S212, the controller side control circuit 210 executes transition display. If the image display range IR1 is changed to the image display range IR2 or IR3 in accordance with the instruction for zooming in or zooming out, a shortage of information in the display composing information may arise. Therefore, until the image data I2 corresponding to the image display range IR2 or the image data I3 corresponding to the image display range IR3 is generated in accordance with the zoom operation, the controller side control circuit 210 generates transition image data, which is pseudo image data I2 or I3, and displays it on the display 272. For example, in the zoom-in operation, the image processing circuit 120 generates transition image data by enlarging the acquired captured image data I1 to fit to the updated image display range IR2. For example, in the zoom-out operation, the image processing circuit 120 generates transition image data by superimposing image data generated by reducing the acquired captured image data I1 to fit to the image display range IR3 and image data obtained by processing the acquired captured image data I1 with image processing for increasing the transparency. The transition display of this embodiment is made to deal with a delay of image data display when obtaining supplemental information to compensate for the shortage of information resulting from the user's intuitive operation by mechanically moving the imaging section 151 to capture an image. The user U1 can get a reaction of the controller 200 in accordance with the user's operation by the transition display. Therefore, the transition display can improve the maneuvering feeling of the user. If zooming that can be handled by a digital zoom operation is instructed, a transition display may not be performed.

In step S213, the controller side control circuit 210 generates signals including specific position information, which relates to the specific position set by the user, and transmits the signal to the observation apparatus 100. The controller side control circuit 210 also generates the control signal to designate an image display range, and transmits it to the observation apparatus 100. The control signal includes a control signal to cause the imaging section 151 to capture an image at a supplemental imaging position, if there is a shortage of information. Then, the processing proceeds to step S214. The processing of this step corresponds to step S108 and step S109.

In step S214 the controller side control circuit 210 determines whether or not supplemental information to compensate for the shortage of information, an observation result, a measurement result, or the like was received. The supplemental information to compensate for the shortage of information is, for example, supplemental image data. The processing proceeds to step S215, if it is determined that the data was received. If not, the processing proceeds to step S216.

In step S215, the controller side control circuit 210 acquires the supplemental information, the observation result, the measurement result, or the like acquired by the observation apparatus 100, and causes the display 272 to display the image data. The image data is generated by adding the supplemental information to the acquired information. The generation of the image data, that is, the addition of the supplemental information to the acquired information, may be performed in either the observation apparatus 100, or the controller 200. The displayed image data includes super-resolution image data, which is the image data I2 corresponding to the image display range IR2, and wide-range image data, which is the image data I3 corresponding to the image display range IR3. The displayed image data may be produced as an image file or a document file. The filing processing may be performed in this step.

The measurement result is obtained from the destination of the measurement result sent from the observation apparatus 100 set in, for example, step S206. In other words, depending on the setting, the measurement result may be directly obtained from the observation apparatus 100, or via the destination, such as a server that receives the measurement result output from the observation apparatus 100. Then, the processing proceeds to step S216. The processing of this step corresponds to step S111 and step S112.

In step S216, the controller side control circuit 210 determines whether or not the inspection application should be ended in accordance with, for example, a result of the user's operation. If it is determined that the inspection application should be ended, the application is ended and the processing returns to step S201. If not, the processing returns to step S203. In the case where the controller 200 and the observation apparatus 100 are continuously connected, no processing may be performed in step S203, or the processing may return to step S204.

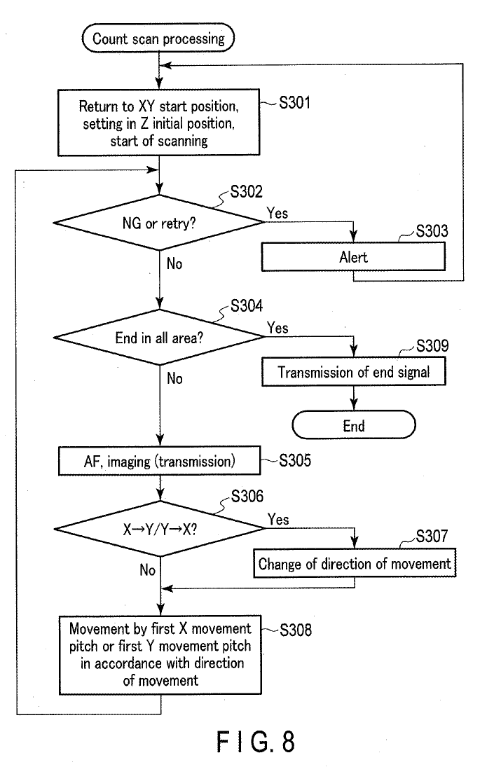

FIG. 8 is a flowchart illustrating an example of count scan processing in step S107 of the observation apparatus control processing. In the following, operations of the observation system 1 in the count scan processing will be explained with reference to FIG. 8.

In step S301, the observation side control circuit 110 executes preprocessing to start count scanning based on count scan processing information stored in, for example, the observation side storage circuit 130. In the preprocessing, the observation side control circuit 110 causes the driving mechanism 160 to move the image acquisition unit 150 and return it to an XY start position of the count scanning. The observation side control circuit 110 also controls operations of the imaging optical system 152 and the image sensor 153, or the driving mechanism 160, so that the count scanning can be started from the initial position in the Z direction. Then, the observation side control circuit 110 starts count scanning.

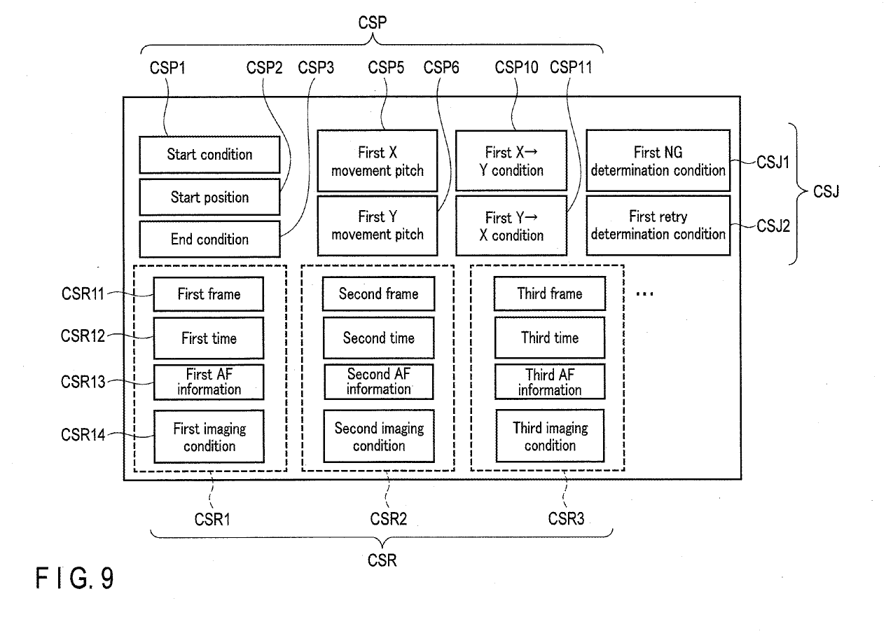

FIG. 9 is a schematic diagram showing an example of information stored as count scan processing information according to this embodiment. Information to be stored as count scan processing information will be explained below with reference to FIG. 9. For example, the information may be set in advance, or may be set in step S105 of the observation apparatus control processing.

As shown in FIG. 9, the count scan processing information includes information CSP relating to a count scan pattern, information CSJ relating to execution of count scan processing, and information CSR obtained by the count scan processing. The information CSP relating to a count scan pattern includes information on, for example, a start condition CSP1, a start position CSP2, an end condition CSP3, a first X movement pitch CSP5, a first Y movement pitch CSP6, a first X-to-Y condition CSP10, which is a condition for changing from an X direction movement to a Y direction movement, and a first Y-to-X condition CSP11, which is a condition for changing from a Y direction movement to an X direction movement, for count scanning. For example, the first X movement pitch CSP5 is a pitch of movement in the X direction, and the first Y movement pitch CSP6 is a pitch of movement in the Y direction. For example, the pitch of movement in the X direction and the pitch of movement in the Y direction are respectively a pitch of image capturing in the X direction and a pitch of image capturing in the Y direction. The image acquisition unit 150 of this embodiment acquires images by performing image capturing at each pitch of movement. The information CSJ relating to execution of count scan processing includes a first NG determination condition CSJ1 and a first retry determination condition CSJ2. The first NG determination condition CSJ1 is a determination condition for determining, for example, an observation failure. The first retry determination condition CSJ2 is a determination condition for determining, for example, whether or not count scanning should be performed again if an observation failure is determined based on the first NG determination condition CSJ1. The information CSR obtained by the count scan processing is stored, for example, in association with each image acquired by the count scan processing. For example, a first result CSR1 includes a first frame CSR11, a first time CSR12 when the first frame CSR11 is acquired, first AF information. CSR13, and a first imaging condition CSR14. The imaging condition includes an exposure condition, such as a shutter speed and an aperture, or the like. The imaging condition may vary from time to time in imaging, from time to time in measurement, or may be the same in all imaging. The information may include information on a position where an image is acquired, a result of counting the number of cells 324, etc.

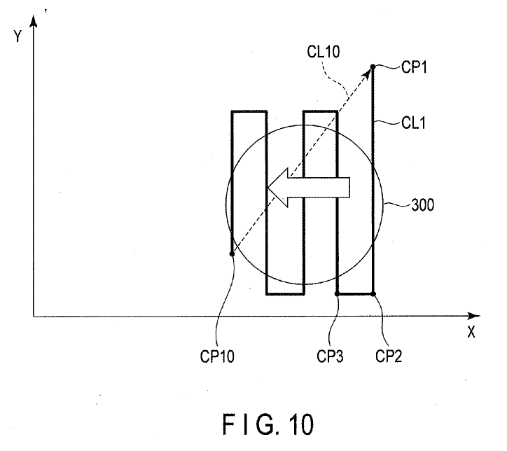

FIG. 10 is a schematic diagram showing an example of a movement pattern of the image acquisition unit 150 in the count scan processing according to this embodiment. Movement of the image acquisition unit 150 in count scanning will be explained below with reference to FIG. 10. In the following, a case of performing count scan processing, while moving the image acquisition unit 150 on a line CL1 shown in FIG. 10, will be explained as an example.

As shown in FIG. 10, the observation side control circuit 110 causes the image acquisition unit 150 to move to a start position CP1 and to acquire an image. The observation side control circuit 110 causes the image acquisition unit 150 to move by the first Y movement pitch in the Y direction and to acquire an image at the position after movement. Thereafter, the observation side control circuit 110 repeats acquisition of an image and movement of the image acquisition unit 150 until it is determined that the first Y-to-X condition CSP11 is satisfied. For example, if the image acquisition unit 150 is located at a position represented by a point CP2, it is determined that the first Y-to-X condition CSP11 is satisfied. If it is determined that the first Y-to-X condition CSP11 is satisfied, the observation side control circuit 110 changes the direction of movement of the image acquisition unit 150 from the Y direction to the X direction. After the direction of movement is changed to the Y direction, the observation side control circuit 110 repeats acquisition of an image and movement of the image acquisition unit 150 by the first X movement pitch until it is determined that the first X-to-Y condition CSP10 is satisfied. For example, if the image acquisition unit 150 is located at a position represented by a point CP3, it is determined that the first X-to-Y condition CSP10 is satisfied. Thus, the observation side control circuit 110 continues the count scan processing until it is determined that the end condition CSP3 is satisfied; for example, that the image acquisition unit 150 reaches a point CP10.

Referring back to FIG. 8, explanations of the count scan processing of the observation system 1 will be continued.

In step S302, the observation side control circuit 110 determines a count scanning state. In the determination, for example, if an observation failure is detected when analyzing the image captured by the image processing circuit 120, or if an operation failure of the driving mechanism 160 is detected, it is determined that the count scanning must be performed again. Conditions for the determination are stored in the observation side storage circuit 130 as count scan processing information, as shown in FIG. 9. In a possible specification, the image acquired in the count scanning may be transmitted to the controller 200, so that the user can determine a count scanning state based on a live view (LV) displayed on the controller 200. The processing proceeds to step S303 if it is determined that the count scanning must be performed again. If not, the processing proceeds to step S304.

In step S303, the observation side control circuit 110 issues an alert to the user, informing that an observation failure has occurred in the count scanning, or that the count scanning must be performed again in accordance with the determination result in step S302. At this time, the observation side control circuit 110 generates a control signal to alert the user and transmits it to the controller 200. The processing then returns to step S301.

The count scan processing, after the processing returns to step S301, is performed again with the image acquisition unit 150 returned to the initial position or at the current position, in accordance with, for example, the determination result in step S302.

In step S304, the observation side control circuit 110 determines whether or not the count scanning was ended in all predetermined areas based on, for example, the end condition CSP3. The end condition CSP3 is stored in, for example, the observation side storage circuit 130 as count scan processing information. The processing proceeds to step S309 if it is determined that the count scanning was ended in all areas. If not, the processing proceeds to step S305.

In step S305, the observation side control circuit 110 causes the imaging section 151 to perform auto focusing (AF) on the cells 324 as an object of attention. The observation side control circuit 110 also causes the imaging section 151 to capture an image of the cells 324 as the object of attention. Furthermore, as described above with reference to FIG. 9, the observation side control circuit 110 causes the observation side communication device 140 to transmit the acquired image or the like to the preset destination. The transmitted image is subjected to image processing, or is used for an analysis in the destination. For example, in an analysis based on the image, the number of cells 324 or cell groups is counted. The analysis may be performed either in the controller 200 or outside the observation system 1. The outside of the observation system 1 includes an image processing circuit of a server, for example, on a cloud network. The result of counting of the cells performed outside the observation system 1 is transmitted to the observation apparatus 100 or the controller 200, and stored in the observation side storage circuit 130 or the controller side storage circuit 230. The counting of the cells may be performed based on a wide-range high-resolution image, which is synthesized on the basis of the acquired image, after the count scan processing in all areas is ended. In this case, the wide-range high-resolution image may be generated outside the observation apparatus 100. Then, the processing proceeds to step S306.

In step S306, the observation side control circuit 110 determines whether or not the current state satisfies the first X-to-Y condition CSP10 or the first Y-to-X condition CSP11 stored as the count scan processing information. If it is determined that the current state satisfies the first X-to-Y condition CSP10 or the first Y-to-X condition CSP11, the processing proceeds to step S307. If not, the processing proceeds to step S308.

In step S307, the observation side control circuit 110 changes the direction of movement of the image acquisition unit 150 in accordance with the determination result in step S306. Then, the processing proceeds to step S308.

In step S308, the observation side control circuit 110 causes the image acquisition unit 150 to move by the first X movement pitch or the first Y movement pitch in accordance with the direction of movement at that time. The processing then returns to step S302.

In step S309, the observation side control circuit 110 causes the observation side communication device 140 to transmit an end signal to the controller 200 in accordance with the determination result in step S304 that the count scanning in all areas was ended. Then, the count scan processing is ended, and the processing proceeds to step S108 of the observation apparatus control processing.

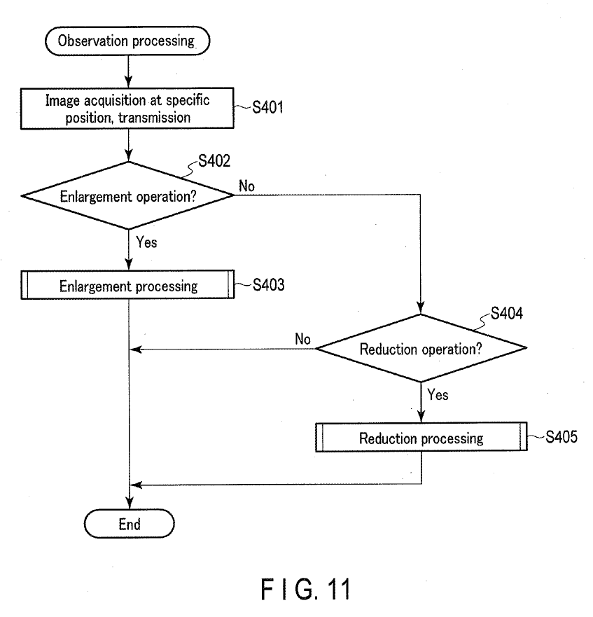

FIG. 11 is a flowchart illustrating an example of observation processing in step S109 of the observation apparatus control processing. In the following, operations of the observation system 1 in the observation processing will be explained with reference to FIG. 11.

In step S401, the observation side control circuit 110 causes the driving mechanism 160 to move the imaging section 151 to the specific position based on the specific position information received in step S108. The observation side control circuit 110 causes the imaging section 151 to perform image capturing at the specific position and to acquire an image. The observation side control circuit 110 causes the observation side communication device 140 to transmit the acquired image to the controller 200.

In step S402, the observation side control circuit 110 determines whether or not an enlargement instruction was received from the controller 200. The enlargement instruction is a control signal relating to an enlargement operation. The enlargement operation is the user's operation for zooming in. The processing proceeds to step S403 if it is determined that the enlargement instruction was received. If not, the processing proceeds to step S404.

In step S403, the observation side control circuit 110 executes enlargement processing. The enlargement processing is processing that relates to acquisition of supplemental information in the enlargement operation. The enlargement processing will be detailed later. After completion of the enlargement processing, the observation processing is ended and the processing proceeds to step S110 of the observation apparatus control processing.

In step S404, the observation side control circuit 110 determines whether or not a reduction instruction was received from the controller 200. The reduction instruction is a control signal relating to a reduction operation. The reduction operation is the user's operation for zooming out. The processing proceeds to step S405 if it is determined that the reduction instruction was received. If not, the observation processing is ended and the processing proceeds to step S110 of the observation apparatus control processing.

In step S405, the observation side control circuit 110 executes reduction processing. The reduction processing is processing that relates to acquisition of supplemental information in the reduction operation. The reduction processing will be detailed later. After completion of the reduction processing, the observation processing is ended and the processing proceeds to step S110 of the observation apparatus control processing.

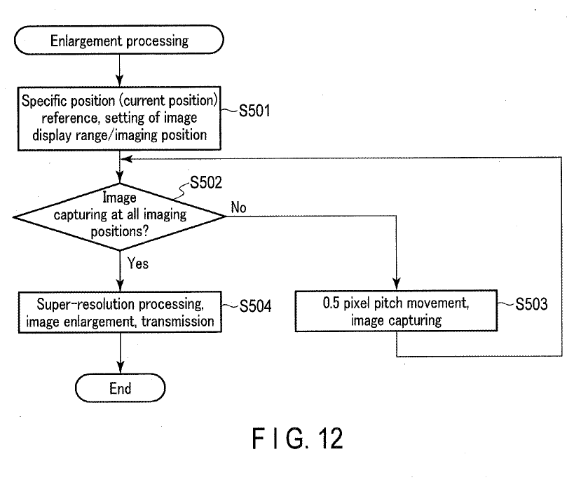

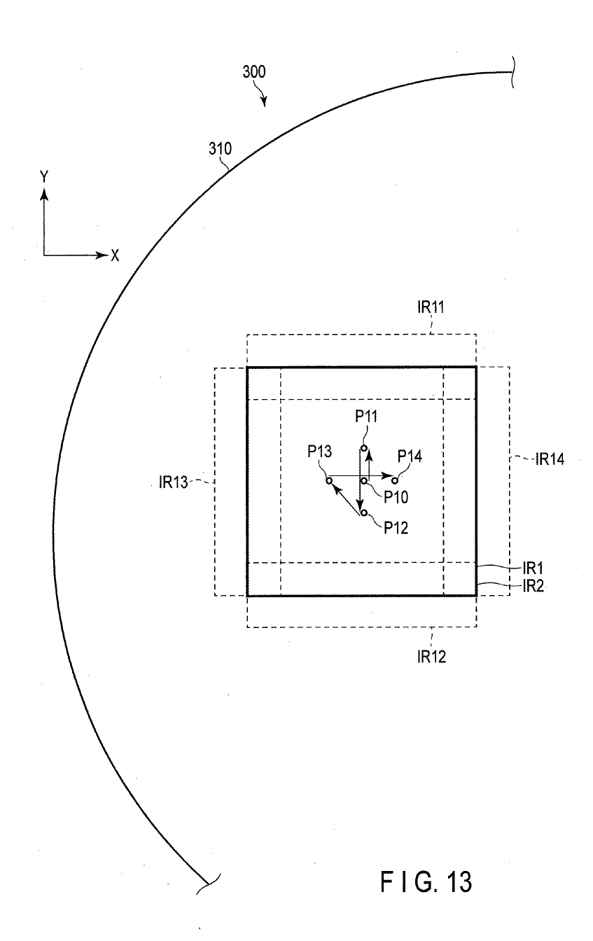

FIG. 12 is a flowchart illustrating an example of enlargement processing in step S403 of the observation processing. FIG. 13 is a schematic diagram showing an example of a movement pattern of the image acquisition unit 150 in the enlargement processing. In the following, operations of the observation system 1 in the enlargement processing will be explained with reference to FIG. 12 and FIG. 13.

In step S501, the observation side control circuit 110 executes preprocessing to start acquisition of supplemental information that compensates for a shortage of information caused by zooming in. The display range setting section 111 sets the image display range IR2 in accordance with the enlargement instruction acquired in step S402. The imaging position setting section 112 reads a T movement pattern stored in the observation side storage circuit 130. The imaging position setting section 112 sets a specific position P10 as a reference of the image display range IR2, as shown in FIG. 13. The specific position P10 is, for example, a current position of the image acquisition unit 150. The imaging position setting section 112 sets supplemental imaging positions and a movement route of the image acquisition unit 150 based on the set image display range IR2, the imaging range, and the T movement pattern. The supplemental imaging positions include a plurality of imaging positions set in this processing. The T movement pattern in this embodiment is a movement route starting from the specific position P10 as a start position, and passing through a supplemental imaging position P11, a supplemental imaging position P12, a supplemental imaging position P13, and a supplemental imaging position P14. The supplemental imaging position P11 is a position shifted from the specific position P10 by, for example, 0.5 pixels in the Y+ direction. The supplemental imaging position P12 is a position shifted from the specific position P10 by, for example, 0.5 pixels in the Y− direction. The supplemental imaging position P13 is a position shifted from the specific position P10 by, for example, 0.5 pixels in the X− direction. The supplemental imaging position P14 is a position shifted from the specific position P10 by, for example, 0.5 pixels in the X+ direction. The captured image data acquired by capturing images at the supplemental imaging positions are image data corresponding to information shortage ranges. In other words, the supplemental image data acquired by capturing images at the supplemental imaging positions are supplemental information corresponding to the information shortage ranges. At this time, the information shortage ranges include an information shortage range IR11, an information shortage range IR12, an information shortage range IR13, and an information shortage range IR14. Since image capturing at the specific position P10 as the imaging position was performed in step S401 of the observation processing, the image display range IR1 before the change is the acquired range, as shown in FIG. 13.

In step S502, the observation side control circuit 110 determines whether or not the image capturing at the set supplemental imaging positions was all completed. If it is determined that the image capturing at the set supplemental imaging positions was all completed, the processing proceeds to step S504. If not, the processing proceeds to step S503.

In step S503, the position control section 113 causes the driving mechanism 160 to move the image acquisition unit 150 to a next supplemental imaging position. As described above, the pitch of T movement in this embodiment is, for example, 0.5 pixels. However, the pitch of T movement is not limited to this example. The pitch of T movement is a distance between each of the supplemental imaging positions and the specific position P10 as the reference. The pitch of T movement may be a distance that can compensate for information per pixel corresponding to a shortage, which cannot be obtained from the acquired image data; for example, it may be greater than 0 and smaller than one pixel. Then, the proceeding returns to step S502, and the processing of step S502 and step S503 is repeated until it is determined in step S502 that the image capturing at the supplemental imaging positions set was all completed.

In step S504, the observation side control circuit 110 causes the image processing circuit 120 to perform super-resolution processing based on information relating to the acquired range and the supplemental information. The information relating to the acquired range is, for example, acquired image data. The supplemental information is, for example, supplemental image data. The observation side control circuit 110 generates image data I2 corresponding to the set image display range IR2. The image data I2 is super-resolution image data. The observation side control circuit 110 causes the observation side communication device 140 to transmit to the controller 200 the generated image data I2 corresponding to the set image display range IR2. Then, the enlargement processing is ended.

As described above, in the enlargement processing of this embodiment, the observation system 1 acquires supplemental information that compensates for information per pixel. The observation system 1 thus increases the amount of information per pixel to compensate for a shortage of information caused by the enlargement operation by the user, so that image data corresponding to the enlargement operation by the user can be generated. In other words, the observation system 1 acquire image data not only by repeatedly capturing images of the image display range according to the user's operation, the observation system 1 also acquires supplemental information by actually moving the image acquisition unit 150 to compensate for information corresponding to a shortage per pixel that cannot be obtained merely by cutting the acquired image data in the image display range according to the user's operation. As described above, the observation system 1 adds supplemental information to the acquired image data, while maintaining the acquired image data.

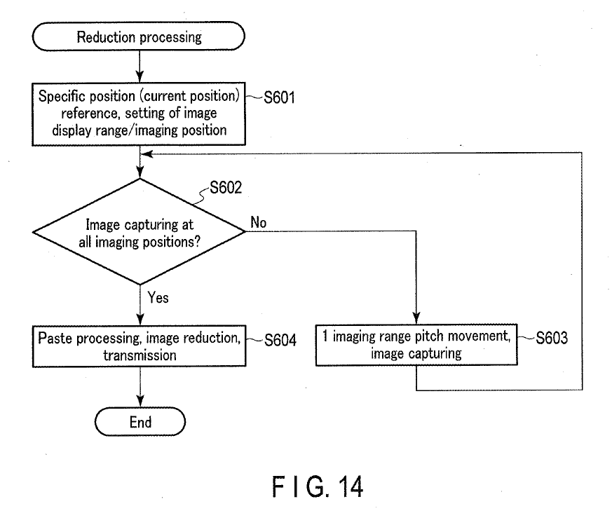

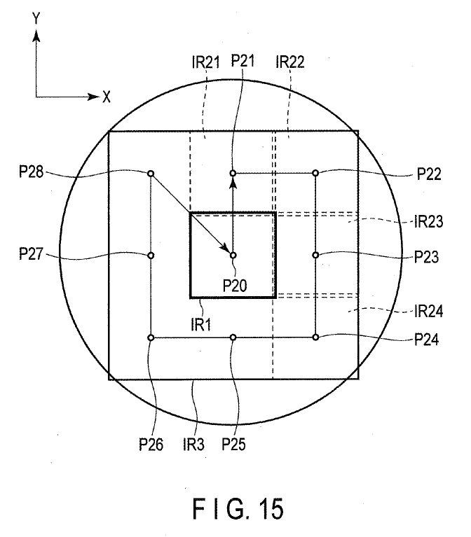

FIG. 14 is a flowchart illustrating an example of the reduction processing in step S405 of the observation processing. FIG. 15 is a schematic diagram showing an example of a movement pattern of the image acquisition unit 150 in the reduction processing. In the following, operations of the observation system 1 in the reduction processing will be explained with reference to FIG. 14 and FIG. 15.

In step S601, the observation side control circuit 110 executes preprocessing to start acquisition of supplemental information that compensates for a shortage of information caused by zooming out. The display range setting section 111 sets the image display range IR3 in accordance with the reduction instruction acquired in step S404. The imaging position setting section 112 reads a W movement pattern stored in the observation side storage circuit 130. The imaging position setting section 112 sets a specific position P20 as a reference, as shown in FIG. 15. The specific position P20 is, for example, a current position of the image acquisition unit 150. The imaging position setting section 112 sets supplemental imaging positions and a movement route of the image acquisition unit 150 based on the set image display range IR3, the imaging range, and the W movement pattern. The supplemental imaging positions include a plurality of imaging positions set in this processing. The W movement pattern in this embodiment is a movement route starting from the specific position P20 as a start position, and passing through eight supplemental imaging positions P21 to P28. The supplemental imaging position P21 is a position shifted from the specific position P20 by, for example, one imaging range in the Y+ direction. The supplemental imaging position P22 is a position shifted from the supplemental imaging position P21 by, for example, one imaging range in the X+ direction. The supplemental imaging position P23 is a position shifted from the supplemental imaging position P22 by, for example, one imaging range in the Y− direction. The supplemental imaging position P24 is a position shifted from the supplemental imaging position P23 by, for example, one imaging range in the Y− direction. The supplemental imaging position P25 is a position shifted from the supplemental imaging position P24 by, for example, one imaging range in the X− direction. The supplemental imaging position P26 is a position shifted from the supplemental imaging position P25 by, for example, one imaging range in the X− direction. The supplemental imaging position P27 is a position shifted from the supplemental imaging position P26 by, for example, one imaging range in the Y+ direction. The supplemental imaging position P28 is a position shifted from the supplemental imaging position P27 by, for example, one imaging range in the Y+ direction. In the case of reduction processing, the larger the image display range, the greater the number of supplemental imaging positions. The captured image data acquired by capturing images at the supplemental imaging positions are image data corresponding to information shortage ranges, for example, as shown in FIG. 7B. In other words, the supplemental image data I31 to I38 acquired by capturing images at the supplemental imaging positions are supplemental information corresponding to the information shortage ranges. At this time, the information shortage ranges include an information shortage range IR21, an information shortage range IR22, an information shortage range IR23, and an information shortage range IR24. Since image capturing at the specific position P20 as the imaging position was performed in step S401 of the observation processing, the image display range IR1 before the change is the acquired range, as shown in FIG. 15. Imaging ranges of the supplemental image data may overlap. In other words, the distance between supplemental imaging positions is, for example, greater than 0 and smaller than one imaging range. The image processing circuit 120 performs trimming processing for the supplemental image data, and omits supplemental information overlapping between the supplemental image data.

In step S602, the observation side control circuit 110 determines whether or not the image capturing at the set supplemental imaging positions was all completed. If it is determined that the image capturing at the set supplemental imaging positions was all completed, the processing proceeds to step S604. If not, the processing proceeds to step S603.

In step S603, the position control section 113 causes the driving mechanism 160 to move the image acquisition unit 150 to a next supplemental imaging position. The distance between each supplemental imaging position of this embodiment and the specific position P20 as the reference corresponds to, for example, one imaging range. The distance corresponding to one imaging range corresponds to a size of one imaging range. Then, the processing returns to step S602, and the processing of step S602 and step S603 is repeated until it is determined in step S602 that the image capturing at the supplemental imaging positions set was all completed.

In step S604, the observation side control circuit 110 causes the image processing circuit 120 to perform image processing to paste the acquired image data and the supplemental image data to each other. The acquired image data is information on the acquired range. The supplemental image data is supplemental information. The observation side control circuit 110 generates image data I3 corresponding to the set image display range IR3. The image data I3 is wide-range image data. The observation side control circuit 110 causes the observation side communication device 140 to transmit to the controller 200 the generated image data I3 corresponding to the set image display range IR3. Then, the reduction processing is ended.

As described above, in the reduction processing of this embodiment, the observation system 1 acquires supplemental information that supplements pixel information around the acquired range. The observation system 1 thus increases the amount of information around the acquired range to compensate for a shortage of information caused by the reduction operation by the user, so that image data corresponding to the reduction operation by the user can be generated. In other words, the observation system 1 acquires image data not only by repeatedly capturing images of the image display range according to the user's operation, the observation system 1 also acquires supplemental information by actually moving the image acquisition unit 150 to supplement ambient information corresponding to a shortage that cannot be obtained from the acquired image data in the image display range according to the user's operation. Thus, the observation system 1 adds supplemental information to the acquired image data, while maintaining the acquired image data.

The observation system 1 of this embodiment sets an image display range according to the user's zoom operation, and generates image data corresponding to the set image display range. The observation system 1 of this embodiment determines whether or not there is a shortage of information in display composing information in accordance with a change in the image display range according to the user's zoom operation. If there is a shortage of information, to acquire supplemental image data, which is supplemental information corresponding to the information shortage range, the observation system 1 of this embodiment causes the imaging section 151 to capture images, while changing the relative position between the imaging section 151 and the sample 300. The observation system 1 of this embodiment adds supplemental image data, which is supplemental information, to the acquired image data, which is acquired information, and generates image data corresponding to the set image display range.

Thus, the observation system 1 of this embodiment can determine a shortage of information caused by the user's zoom operation, and acquire supplemental information to supplement information that cannot be acquired by ordinary optical zooming or electronic zooming. Therefore, the user can acquire image data generated by supplementing the acquired information with supplemental information by using the observation system 1 of this embodiment with only the user's intuitive operation to instruct a zoom-in or zoom-out, without performing a specific operation such as an image capturing instruction.

The observation system 1 of this embodiment generates image data in accordance with the user's operation by supplementing the acquired information with supplemental information. At such time, the observation system 1 may clearly indicate, in image data generated after a zoom-out operation, the range of image data before the zoom operation. The range of image data before the zoom operation is the acquired range. For example, the image display range represented by the image data displayed before the zoom operation is indicated by a frame line in the image data displayed after the zoom operation. Furthermore, the observation system 1 may superimpose, on the image data generated after the zoom-in operation, a map indicating the image display range after the zoom operation with a frame line in the image display range before the zoom operation. In the observation system 1 of this embodiment with the configuration described above, the user can easily ascertain correspondence between the acquired information and the current information supplemented with the supplemental information.

The embodiment, in which image data in accordance with the user's zoom operation is generated in the observation apparatus 100, has been described as an example. However, the embodiment is not limited to this example. The image data in accordance with the user's zoom operation may be generated in the destination, such as the controller 200, set by the observation apparatus 100. In other words, the controller 200 may include an image processing circuit corresponding to the image processing circuit 120.

The embodiment, in which the zoom operations are performed by pinch operations, has been described as an example. However, the embodiment is not limited to this example. For example, the technique of this embodiment can realize an imaging apparatus that zooms in or zooms out in a direction of movement of the imaging apparatus by the user, if the imaging apparatus has an electronic compass or gyro sensor. Furthermore, for example, the technique of this embodiment can realize an imaging apparatus that detects a user's motion, and performs a zoom-in operation when the user looks into the display. User's motions may be acquired through an imaging apparatus fixed to the user, for example, a head-mounted display or an eyeglass-type display, or may be acquired through an external camera.

In this embodiment, such an operation is considered to be an intuitive operation which the user performs even unconsciously. Such an operation may be performed when the user feels something unsatisfactory about the currently displayed image. In this case, the operation may be considered as an operation that reflects the user's need or intention to observe the image in more detail, for example, by enlarging the image. The operation may also be considered as an operation that reflects the user's need or intention to observe the image more comprehensively, for example, by reducing the image. The technique of this embodiment can find out such a need of the user and improve the user's satisfaction level by reflecting the need on the style of display. The user's operation as described above may not necessarily be performed intuitively. If the user finds that the operation can produce a particular advantage, the user may consciously execute it, and the application of this for better observation can be sufficiently presumed. Using the technique of this embodiment, various displays can be seen by intuitive operations as described above. Therefore, the user can switch between displays with a single touch without performing many operations, which are otherwise required.

Although the embodiment has been described particularly focusing on the zoom operations by the user, the technique of this embodiment is not limited to only the zoom operations. The technique of this embodiment can determine a shortage of information caused by the user's intuitive operation, can acquire supplemental information to compensate for the shortage of information, and can generate acquired information supplemented with the supplemental information. For example, the technique of the embodiment can realize an imaging system that acquires a three-dimensional image as three-dimensional information, by an operation of pressing on the touch panel. For example, the display range setting section 111 sets an image display range in the Z-axis direction different from an image display range before a press operation as a reference in accordance with the amount of press in of the touch panel or the time of press in by the user. Image data corresponding to the image display range is three-dimensional image data. The three-dimensional image data may be a stereoscopic image, in which the acquired range is represented as a reference surface. The three-dimensional image data may be displayed by stacking supplemental image data onto the image data corresponding to the acquired range like tiles. The image data corresponding to the acquired range is acquired information. The supplemental image data is supplemental information. Even in this case, the same advantage as that described above can be obtained.

As described above, the imaging apparatus of this embodiment includes the imaging section 151 that captures an image of an object in a specific imaging range, or an imaging range different from the specific imaging range, and outputs an image signal. With the apparatus, the imaging control section 114 causes the imaging section 151 to capture images in various imaging ranges, so that various information can be acquired. At that time, the imaging range varies, for example, by movement of the imaging section 151. The imaging range may vary by providing a plurality of imaging sections 151 and selectively using the imaging sections 151. In other words, since the imaging apparatus of this embodiment includes the display range setting section 111 that sets an image display range in accordance with the user's operation, it is possible to determine whether the user is satisfied with the display. Therefore, if there is a shortage in, for example, the acquired information or the displayed information, the imaging apparatus of this embodiment can satisfy the needs of the user by using a plurality of pieces of image data. In other words, the imaging apparatus of this embodiment may generate image data corresponding to the designated image display range in the image processing circuit 120, using the image signals respectively acquired in the imaging ranges. As a result, the imaging apparatus of this embodiment can enrich the display image as desired by the user by generating image data corresponding to the image display range as synthetic image data obtained by utilizing information acquired by the image signals.

### Second Embodiment

The second embodiment of the present invention will be explained. In the following, matters different from the first embodiment will be explained. Identical reference signs will be used for identical parts, and detailed explanations thereof will be omitted.

In the first embodiment described above, the observation system 1 can compensate for, by image capturing, a shortage of information caused by the user's zoom operation. The image capturing is acquisition of supplemental information. However, the supplemental information acquired by the observation system 1 is not limited to image data acquired by image capturing. In the second embodiment described below, if a zoom-out that exceeds a predetermined amount is instructed, the observation system 1 further acquires, as supplemental information, an observation report acquired by analyzing the result of observation or measurement, to compensate for a shortage of information.

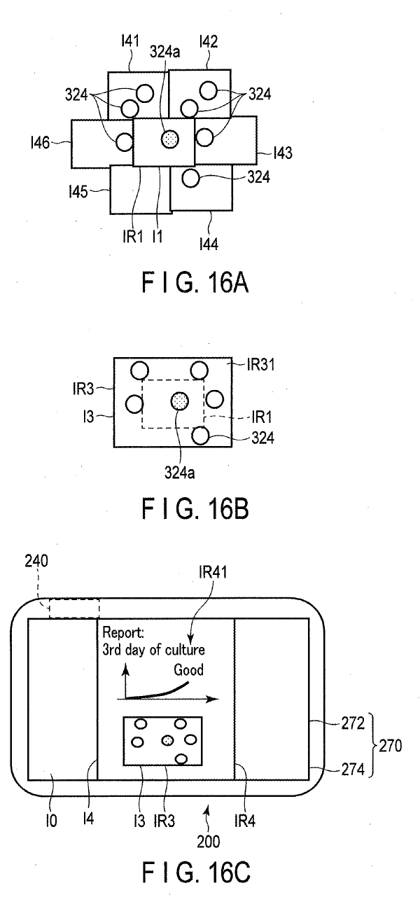

FIG. 16A, FIG. 16B, and FIG. 16C are schematic views for explaining the acquisition of supplemental information in a case where the user's zoom operation to instruct zooming out of a predetermined amount or more in observation processing according to this embodiment is executed. In the following, the acquisition of supplemental information, in a case where a reduction operation of a predetermined amount or more is performed in the observation processing according to this embodiment, will be explained with reference to the schematic views of FIG. 16A, FIG. 16B, and FIG. 16C.

For example, it is assumed that captured image data I1 obtained by imaging a cell 324a is displayed on the display 272 of the controller 200. In this case, the captured image data I1 is image data corresponding to the image display range IR1. For example, if something abnormal is detected in a cell 324a, the user may desire to acquire image data I3 corresponding to the image display range IR3 as shown in FIG. 16B to observe surrounding cells 324. In this case, as described above, the image display range IR3 is set in accordance with the zoom operation to instruct a zoom-out, and supplemental information is acquired. At this time, the supplemental information is supplemental image data I41 to supplemental image data I46. The supplemental image data I41 to supplemental image data I46 are image data corresponding to an information shortage range. In the first embodiment described above, as an example, eight supplemental imaging positions are set in the reduction processing, and eight pieces of supplemental image data are acquired. However, depending on the information shortage range, six supplemental imaging positions may be set and six pieces of supplemental image data may be acquired, as shown in FIG. 16A. Thus, the supplemental imaging positions may be determined appropriately depending on the size of an information shortage range, and any number of positions may be set as long as supplemental information can be acquired.

The amount of feasible zoom-outs is limited by a movable range of the image acquisition unit 150 or the like. Depending on the communication situation between the observation apparatus 100 and the controller 200 or the state of the observation apparatus 100, supplemental information cannot be acquired by image capturing. Therefore, the observation system 1 according to this embodiment generates a report of an observation result as supplemental information, if a zoom-out operation of a predetermined amount or more is instructed. At this time, an image display range IR4, which is set in accordance with the zoom-out operation of the predetermined amount or more, includes the image data I3 corresponding to the acquired information range and a report indicative of an information shortage range IR41. The report is generated based on report composition information including, for example, the image data I3, the result of counting the cells acquired by analyzing the image data I3, the imaging date and time, the imaging place, and information on the observer. The report is not limited to the image data I3, which is current information; the report may also be a summary of observation results, such as image data acquired in the past. For example, the report may be image data indicative of a change in the cells 324 with the passage of time obtained by stacking the current image data onto the past image data like tiles. For example, time-series data of the result of counting the cells may be indicated as a report. In this case, the zoom-out operation of a predetermined amount or more may be expressed as a zoom-out operation to acquire information in a wider range in a time direction. The observation system 1 may display the report thus obtained as shown in FIG. 16C, or produce an image file or another type of file for the report. It is possible, as an application, to confirm the obtained result in another place, such as outside of the observation system 1. For example, it is possible, as an application, to add or attach part of the obtained information as metadata to a file of images or the like. The retrievability of the obtained information can be improved by such an application. Furthermore, the improvement of the retrievability makes it easy to externally confirm or utilize the information obtained by the observation system 1.

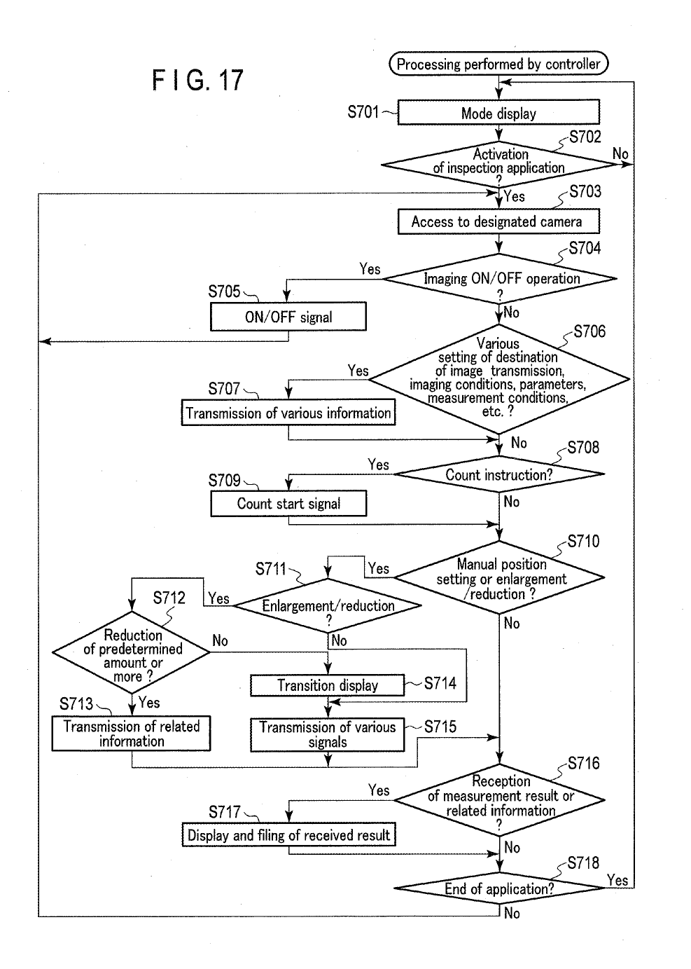

FIG. 17 is a flowchart illustrating an example of processing performed by the controller according to this embodiment. Operations of the observation system 1 in this embodiment will be explained below with reference to FIG. 17. In the following, explanations are given referring to corresponding steps in the processing performed by the controller according to the first embodiment described above with reference to FIG. 5.

The processing in step S701 to step S711 is the same as the processing in step S201 to step S211. If it is determined that the zoom operation was performed in step S711, the processing proceeds to step S712. If not, the processing proceeds to step S714. The zoom operation is an operation to instruct enlargement or reduction.

In step S712, the controller side control circuit 210 determines whether or not an operation to instruct zooming out of a predetermined amount or more was performed. The amount of zooming out of the predetermined amount or more is preset and registered in, for example, the controller side storage circuit 230. The processing proceeds to step S713 if it is determined that the operation to instruct zooming out of the predetermined amount or more was performed. If not, the processing proceeds to step S714.

In step S713, the controller side control circuit 210 generates and transmits a control signal to transmit related information to the observation apparatus 100. The related information includes a report. The report is supplemental information. The report may be generated in the controller 200. In this case, the related information includes report composition information necessary to generate the report. Then, the processing proceeds to step S716.

In step S714 and step S715, in the same manner as in step S212 and step S213, the controller side control circuit 210 performs transition display, and transmits to the observation apparatus 100 a signal including specific position information and a control signal that instructs image capturing to acquire supplemental information. An enlargement operation may be performed in a state of displaying image data supplemented with related information, such as a report. In this case, to generate image data corresponding to the set image display range, the controller side control circuit 210 transmits to the observation apparatus 100 an instruction to acquire supplemental image data by image capturing. Thus, in the observation system 1 of this embodiment, a report is generated when the user reduces an image, and an image is acquired when the user enlarges a report. Then, the processing proceeds to step S716.

In step S716, the controller side control circuit 210 determines whether or not a measurement result or related information was received. The processing proceeds to step S717 if it is determined that the measurement result or related information was received. If not, the processing proceeds to step S718.

In step S717, in the same manner as in step S215, the controller side control circuit 210 acquires the supplemental information, the observation result, and the measurement result acquired by the observation apparatus 100, and causes the display 272 to display image data. In this step, the image data is displayed in accordance with layout information set in advance and stored in the observation side storage circuit 130. The image data displayed in accordance with layout information includes the image data I2 corresponding to the image display range IR2, the image data I3 corresponding to the image display range IR3, and the image data I4 corresponding to the image display range IR4. The image data I2 is super-resolution image data. The image data I3 is wide-range image data. As described above, the image data I4 includes the image data I3 and a report. In the same manner as in step S215, the image data to be displayed may be produced as an image file or a document file. The filing processing may be performed in this step. Then, the processing proceeds to step S718.

In step S718, the controller side control circuit 210 determines whether or not the inspection application should be ended, in the same manner as in step S216. If it is determined that the inspection application should be ended, the application is ended and the processing returns to step S701. If it is determined that the operation should not be ended, the process returns to step S703.

The observation system 1 according to this embodiment has the following advantages in addition to those achieved in the first embodiment. The observation system 1 generates a report of summarizing observation results as supplemental information in accordance with user's zoom-out operation of the predetermined amount or more. Furthermore, as image data corresponding to the image display range set in accordance with the user's zoom operation, the observation system 1 can generate image data, in which image data as acquired information and a report as supplemental information are placed in accordance with the layout information. Therefore, with the observation system 1 of this embodiment, the user can easily acquire related information that supplements the current image data.

The related information acquired as the supplemental information may be a result of an analysis of the current image data, the image data acquired in the past, or a result of an analysis of the past image data. Therefore, the user can relatively evaluate the state indicated by the current image data, using the observation system 1 of this embodiment. For example, the user can easily determine whether or not the current observation result is proper with reference to image data, in which the acquired image data is supplemented with a report indicative of a change in the number of cells, or image data, in which pieces of the acquired image data are stacked in a time series. Thus, the supplemental information acquired by the observation system 1 of this embodiment in accordance with the user's zoom operation is not used only for enlarging and reducing the observation range indicative of image data to be acquired. The supplemental information also includes related information that supplement information read from the acquired image data.

In the embodiment described above, the image data supplemented with a report is generated in the observation apparatus 100, for example. However, the embodiment is not limited to this example. Supplementation of related information, such as a report, to the image data as the acquired information may be performed in the controller 200. Depending on the communication situation, the controller 200 cannot cause the observation apparatus 100 to acquire supplemental image data, or cannot acquire supplemental image data acquired by the observation apparatus 100. Therefore, if the controller 200 is configured to generate a report, even in the situation in which the supplemental image data cannot be acquired depending on the communication situation, the controller 200 can acquire image data supplemented with related information.

Furthermore, in a state of displaying image data supplemented with a report, if a further zoom-out operation is performed, an increase of the kinds of related information to be supplemented may be considered. For example, in the state of displaying a change of results of counting the number of cells, if a further zoom-out operation is instructed, the image data may be supplemented with information relating to a frequency of exchange of culture media or a result of observation of another sample. In the embodiment described above, the observation system 1 supplements a report in accordance with a zoom-out operation of a predetermined amount or more. However, the supplementation of related information, such as a report, may be performed in accordance with a zoom-in operation of a predetermined amount or more.

As described above, the imaging apparatus of this embodiment includes the imaging section 151 that captures an image of an object in a specific imaging range or an imaging range different from the specific imaging range, and outputs an image signal. With the apparatus, the imaging control section 114 causes the imaging section 151 to capture images in various imaging ranges, so that various information can be acquired. At that time, the imaging range varies, for example, by movement of the imaging section 151. Depending on the design, the imaging range may vary by preparing a plurality of imaging sections 151 and selectively using the imaging sections 151. In order to determine whether the user is satisfied with the display of the result of measurement, while observing the display, if the imaging apparatus of this embodiment includes the display range setting section 111 that sets an image display range in accordance with the user's operation, it is possible to determine whether the user is satisfied with the display. For example, if there is a shortage in, for example, the acquired information or the displayed information, the imaging apparatus of this embodiment can satisfy the needs of the user by using a plurality of pieces of image data. In other words, the imaging apparatus of this embodiment may generate image data corresponding to the designated image display range in the image processing circuit 120, using the image signals respectively acquired in the imaging ranges.

As a result, the imaging apparatus of this embodiment can enrich the display image as desired by the user by generating image data corresponding to the image display range as synthetic image data obtained by utilizing information acquired by the image signals. Enrichment of the display image by the synthetic image data can be achieved by not only widening the range of view or improving the degree of resolution, but also by processing the information acquired from the images to be displayed as, for example, a report or a graph. The enrichment of the display image by the synthetic image data may be performed by synthesizing the information obtained from the image with at least one of the displayed images. For the synthesis or generation of information described above, the user must carry out a number of operations according to the conventional art. However, if the technique of this embodiment is applied, the user can generate or display an image with a single touch by an intuitive operation. The information, such as an image to be generated or acquired, is not necessarily displayed in real time. The information is not necessarily displayed, but may only be generated or acquired. The technique may also allow acquisition of new information by an operation for a display image. The information obtained as described above may be added or attached as metadata to an image file or the like by applying the embodiment.

The imaging apparatus of the embodiment is described as the observation apparatus 100, for example. However, the embodiment is not limited to this example. The technique of the embodiment is applicable to an imaging apparatus that can capture images while changing the imaging range. For example, application of the technique can realize a digital camera that performs super-resolution processing when a zoom-out operation of a predetermined amount or more is instructed. Furthermore, the technique may be applied to a monitoring camera. After a zoom operation, the user can check image data generated by supplementing the currently observed image with supplemental image data. Therefore, the user can change the range of monitoring to check a target of monitoring in more detail, or check the surrounding of the target without losing sight of the target. Furthermore, the user can check a report which records the number of persons passing through the range of monitoring or a change in the target of monitoring in accordance with the zoom operation of a predetermined amount or more. The technique can also be applied to a flying-type camera, such as a drone, or a mobile camera, such as a self-propelled robot camera. In this case, even in remote imaging, the user can easily ascertain the relative position between image data acquired before and after the zoom operation. In a case of using such a mobile camera in agriculture, the user can easily check image data supplemented with a report which records growth conditions of crops. Furthermore, the technique can be applied to an endoscopic camera. In this case, the user can change the range of inspection to check a target of treatment in more detail or check the surrounding of the target without losing sight of the target. Furthermore, the user can check a report like a medical record which records information relating to treatment, such as a change in the target of treatment, treatment time, etc. in accordance with the zoom operation of a predetermined amount or more. The imaging apparatus of the embodiment may be configured as an imaging system. For example, results of image capturing by a plurality of cameras may, of course, be appropriately synthesized, so that the same advantages as described above can be attained. At this time, instead of using a plurality of cameras, an imaging apparatus including a plurality of imaging lenses or an imaging lens divided into a plurality of parts may be used to appropriately synthesize results of image capturing. With the intuitive operations described above, various displays can be presented or information such as images can be obtained. Therefore, the user can switch between displays with a single touch without performing many operations, which are otherwise required.

The order of processing shown in the flowcharts and the order of steps in each process may be changed, and processing or steps may be added or deleted. Each processing is executed by a program stored in the observation apparatus 100 and the controller 200. Each program may be internally stored in the observation apparatus 100 and the controller 200 in advance, or may be externally recorded in a separate recording medium. The programs can be recorded in various ways. They can be recorded at the time of shipping a product, they can be recorded using a distributed recording medium, or can be downloaded using a communication network, such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

In the embodiments, a part named as a section or a unit may be structured by a dedicated circuit or a combination of a plurality of general purpose circuits, and may be structured by a combination of a microcomputer operable in accordance with a pre-programmed software, a processor such as a CPU, or a sequencer such as an FPGA. In addition, a design where a part of or total control is performed by an external device can be adopted. In this case, a communication circuit is connected by wiring or wirelessly. Communication may be performed by means of Bluetooth, Wi-Fi, a telephone line, or a USB. A dedicated circuit, a general purpose circuit, or a controller may be integrally structured as an ASIC. A specific mechanical functionality (that can be substituted by a robot when a user images while moving) may be structured by various actuators and mobile concatenating mechanisms depending on the need, and may be structured by an actuator operable by a driver circuit. The driver circuit is controlled by a microcomputer or an ASIC in accordance with a specific program. The control may be corrected or adjusted in detail in accordance with information output by various sensors or peripheral circuits.

What is claimed is:

1. An imaging apparatus comprising:
an imaging section configured to capture images of an object at different imaging positions and output image signals based on the images;
a user's operation detecting circuit configured to detect a user's operation;
a control circuit configured to change an image display range in accordance with the user's operation, and cause the imaging section to capture the images at the different imaging positions in accordance with the changed image display range; and
an image processing circuit configured to generate image data using the image signals acquired at the imaging positions, the image data corresponding to an area of the image display range changed by the user's operation.

2. The imaging apparatus according to claim 1, wherein the image data corresponding to the image display range is synthetic image data synthesized using information acquired from the image signals.

3. The imaging apparatus according to claim 2, wherein the synthetic image data is generated by synthesizing the image signals or synthesizing at least one of the image signals and information processed to be displayable from the information obtained from the image signals.

4. The imaging apparatus according to claim 1, wherein the image processing circuit is configured to generate an image file by filing the image data, and attach information obtained from the image signals as meta data to the image file.

5. The imaging apparatus according to claim 1, further comprising a driving mechanism configured to move the imaging section to change a relative position between the object and the imaging positions, wherein
the control circuit is configured to set the imaging positions where the imaging section captures the images of the object based on the image display range and an imaging range of the imaging section, and control operations of the driving mechanism to move the imaging section to the imaging positions.

6. The imaging apparatus according to claim 5, wherein:
the control circuit is further configured to set, in the image display range, an acquired range for which corresponding information is already acquired and an information shortage range which requires supplemental information to supplement a shortage of information caused by the user's operation, and sets the imaging positions based on the information shortage range; and
the image processing circuit is configured to generate the image data by supplementing the information corresponding to the acquired range with the image signals as the supplemental information.

7. The imaging apparatus according to claim 5, wherein the control circuit is configured to set the imaging positions to image a range shifted from the image display range by a distance greater than 0 and smaller than one pixel, when the user's operation is a zoom operation to instruct zooming in.

8. The imaging apparatus according to claim 7, wherein the image processing circuit is configured to perform super-resolution processing using the image signals, and generate super-resolution image data as the image data.

9. The imaging apparatus according to claim 5, wherein the control circuit is configured to set the imaging positions to image at an interval greater than 0 and smaller than one imaging range, when the user's operation is a zoom operation to instruct zooming out.

10. The imaging apparatus according to claim 9, wherein the image processing circuit is configured to synthesize the image signals acquired in the different imaging positions, and generate wide-range image data as the image data.

11. The imaging apparatus according to claim 5, wherein the image processing circuit is further configured to generate image data to display information relating to the image data already acquired, when the user's operation is a zoom operation of a predetermined amount or more.

12. The imaging apparatus according to claim 5, wherein the image processing circuit is further configured to analyze the image data already acquired, and generate further image data to display an analysis result, when the user's operation is a zoom operation of a predetermined amount or more.

13. The imaging apparatus according to claim 5, wherein:
when the user's operation is an operation to instruct acquisition of three-dimensional information, the control circuit is configured to set the image display range acquired before the user's operation as a reference surface, and set another image display range on another position along a Z-axis direction perpendicular to the reference surface; and
the image processing circuit is configured to generate three-dimensional data corresponding to the image display range representing the reference surface.

14. The imaging apparatus according to claim 5, wherein the control circuit is configured to set the imaging positions, when the user's operation is a zoom operation of a predetermined amount of more and a shortage of information is caused by the user's operation.

15. The imaging apparatus according to claim 5, wherein the image processing circuit is further configured to generate transition image data, which is pseudo image data displayed after the user's operation until the image data is generated.

16. The imaging apparatus according to claim 5, wherein the image processing circuit is configured to generate the image data by superimposing a frame corresponding to the image display range set before the user's operation on the image data.

17. An imaging system comprising:
the imaging apparatus according to claim 1; and
a controller including an operation section configured to acquire a result of the user's operation.

18. A method for controlling an imaging apparatus including an imaging section configured to capture images of an object at different imaging positions and output image signals based on the images, the method comprising:
detecting a user's operation;
changing an image display range in accordance with the user's operation;
causing the imaging section to capture the images at the different imaging positions in accordance with the changed image display range; and
generating image data using the image signals acquired at the imaging positions, the image data corresponding to an area of the image display range changed by the user's operation.

19. The method according to claim 18, further comprising:
setting the imaging positions where the imaging section captures the images of the object based on the image display range and an imaging range of the imaging section; and
moving the imaging section to the imaging positions.

20. The method according to claim 19, wherein:
the changing the image display range includes setting, in the image display range, an acquired range for which corresponding information is already acquired and an information shortage range which requires supplemental information to supplement a shortage of information caused by the user's operation;
the setting the imaging positions is performed based on the information shortage range of the image display range; and
the generating image data is performed by supplementing information corresponding to the acquired range with the image signals as the supplemental information.
